(19) United States
(12) Patent Application Publication
(10) Pub. No.: US 2013/0246110 A1
(43) Pub. Date: Sep. 19, 2013

(54) VISUALIZING RESOURCE REQUIREMENTS ALONG A TIMELINE

(71) Applicants: Babak Nakhayi Ashtiani, Redmond, WA (US); Rupa Mantravadi, Redmond, WA (US); Ramesh Guruaja, Sammamish, WA (US); Jeff D. Comstock, Mercer Island, WA (US); Julianne Prekaski, Seattle, WA (US)

(72) Inventors: Babak Nakhayi Ashtiani, Redmond, WA (US); Rupa Mantravadi, Redmond, WA (US); Ramesh Guruaja, Sammamish, WA (US); Jeff D. Comstock, Mercer Island, WA (US); Julianne Prekaski, Seattle, WA (US)

(73) Assignee: MICROSOFT CORPORATION, Redmond, WA (US)

(21) Appl. No.: 13/615,664

(22) Filed: Sep. 14, 2012

Related U.S. Application Data
(60) Provisional application No. 61/611,398, filed on Mar. 15, 2012.

(51) Int. Cl. G06Q 10/06

(52) U.S. Cl. 705/7.13

(57) ABSTRACT

A work definition is generated. The work definition includes resource requirements needed to perform tasks in the work definition. The resource requirements are displayed along a timeline. Resource availability can also be displayed along the same timeline.

The present application is based on and claims the benefit of U.S. provisional patent application Ser. No. 61/611,398, filed Mar. 15, 2012, the content of which is hereby incorporated by reference in its entirety.

### BACKGROUND

In the manufacturing sector, there is a differentiation between built-to-stock items (which are often mass produced) and custom items (which are made to order). For example, on one computer manufacturer's website, a customer can choose a computer with a standard configuration, off-the-shelf and ready to ship, or the customer can define the specifications for a new computer that will be built for them, feature-by-feature. By way of example, the customer can specify which hard drive is to be used in the computer, how much random access memory (RAM) is to be provided in the computer, which graphics card to use, etc. There are some software systems that support both of these types of manufacturing scenarios.

This is not true, however, for the project-based industry. For instance, assume a project-based company is a software services company. Such a company employs resources who specialize in different areas of technology, such as developers, testers, designers, project managers, architects, database administrators, etc. The company uses the collective expertise of these resources in order to provide a wide variety of services to its customers. The same is true in other areas as well. For instance, where the project-based company is a construction company, the company employs resources such as workers and various equipment and machinery. These resources all must be scheduled at different construction sites where the company is working.

Some current project management software solutions provide a user interface display that shows a project work plan along a timeline. The work plan (sometimes often referred to as a work definition) can be in a form of a hierarchical task structure that is sometimes referred to as a work breakdown structure (WBS). The work breakdown structure defines the tasks required to complete a project and arranges them in a generally hierarchical arrangement. This type of graphical visualization is also commonly referred to as a Gantt chart.

In order to complete each of the tasks, certain resources are required. The resource requirements (which are often a collection of one or more resource capabilities) that are needed in order to complete the work effort are currently expressed and visualized in separate displays or grids, which are displayed separately from the Gantt chart. Alternatively, some explanatory text can be displayed along with the work plan in the Gantt chart. Therefore, in order to assign resources to the various tasks in a project plan, a project manager must often navigate between multiple different displays. One display is the project plan that shows the arrangement of the tasks. A second display shows the resource requirements corresponding to an individual task, and the third display shows available resources that can be used by the project manager to meet the resource requirements in the second display. This results in a project manager or resource manager having a generally disconnected experience when attempting to staff a project. It requires them to access the information they need, from several different places.

The discussion above is merely provided for general background information and is not intended to be used as an aid in determining the scope of the claimed subject matter.

### SUMMARY

A work definition is generated. The work definition includes resource requirements needed to perform tasks in the work definition. The resource requirements are displayed along a timeline. Resource availability can also be displayed along the same timeline.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative project management system.

FIG. 2 is a flow diagram illustrating one embodiment of the overall operation of the system shown in FIG. 1.

FIGS. 2A-2E are illustrative user interface displays.

FIG. 3 is a flow diagram illustrating one embodiment of the operation of the system shown in FIG. 1 in generating a plan and mapping it to a definition of deliverables.

FIG. 3A-3D show embodiments of illustrative user interface displays.

FIGS. 4A and 4B show a flow diagram illustrating one embodiment of the operation of the system shown in FIG. 1 in assigning resources to resource requirements in a project plan.

FIGS. 4C-4F are illustrative user interface displays.

FIG. 5 is a diagram of a data model.

FIG. 6 illustrates one embodiment of the system shown in FIG. 1 in a cloud computing architecture.

FIGS. 7-11 illustrate various embodiments of mobile devices.

FIG. 12 shows one embodiment of an illustrative computing environment.

### DETAILED DESCRIPTION

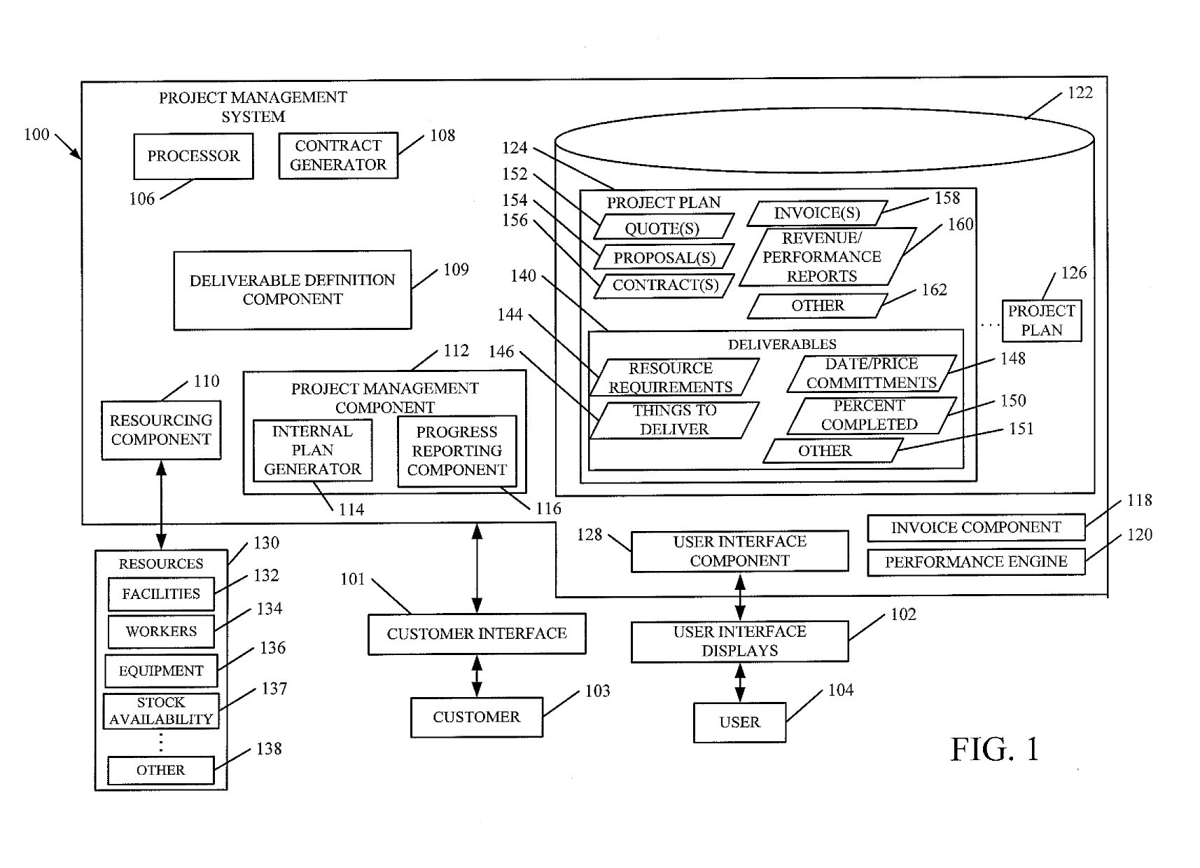

FIG. 1 is a block diagram of one illustrative project management system 100. FIG. 1 shows that system 100 generates user interface displays 102. In one embodiment, user interface displays 102 have user input mechanisms for receiving inputs from user 104 so that user 104 can interact with, and control, project management system 100. The user input mechanisms can be elements that allow the user to provide inputs using a point and click device, a keyboard, touch gestures, voice, etc.

Project management system 100 can operate in a wide variety of different ways, depending on the nature of the particular project being managed. For the sake of example, the project discussed herein is a computer software project. However, it could just as easily be a construction project, a demand replenishment project in a supply chain logistics context, or another project. System 100 allows user 104 to generate a proposal to a computer (in terms of deliverables), generate a contract, develop a project plan, assign resources to the plan, manage the project during its execution and report on its performance. The present discussion is primarily directed to assigning the resources, but other steps will be described as well, for the sake of one exemplary context. Of course, the other steps are optional and are described for the sake of example only.

FIG. 1 shows that project management system 100 includes processor 106, contract generator 108, deliverable definition component 109, resourcing component 110, project management component 112 (which, itself, includes internal plan generator 114 and progress reporting component 116), invoice component 118, performance engine 120, data store 122 (which stores a plurality of project plans 124 and 126), and user interface component 128. User interface component 128 is used by other components of system 100 to generate user interface displays 102.

FIG. 1 also shows that a customer 103 can illustratively provide communication with user 104 either directly (as indicated by arrow 105) or through system 100 using customer interface 101. Interface 101 can have input mechanisms that receive inputs from customer 103 for communicating with user 104.

In one embodiment, processor 106 is illustratively a computer processor with associated memory and timing circuitry (not shown). It is illustratively a functional part of system 100 and is activated by, and facilitates the functionality of, other components, generators and engines in system 100. Data store 122 is shown as part of system 100, but it can be separate from system 100 or located remotely from system 100, as well. In addition, data store 122 is shown as a single data store but it could be multiple data stores distributed in multiple locations as well.

FIG. 1 also shows that system 100 is illustratively connected to a source of resources 130 that can be assigned by resourcing component 110, to a given project plan. Resources 130 illustratively include facilities 132, workers 134, equipment 136 stock availability 137, and other resources 138. FIG. 1 also illustrates that, in one embodiment, a project plan 124 illustratively includes the definition of a deliverable 140 that is defined by deliverable definition component 109. The deliverable can be defined in a number of ways, such as by specifying the resource requirements 144 that are needed to provide the deliverable, the specific things to deliver 146, the delivery date and price commitments 148, and a percent completed portion 150 that can be updated to show the percentage of a given deliverable that has been completed during a project. The deliverable 140 is defined for external use, such as for presentation to a customer.

Before describing the operation of system 100 in more detail, a brief overview will be given. In one embodiment, user 104 interacts with system 100 through user interface displays 102 to control deliverable definition component 109 to define a deliverable. This can be done in conjunction with input from a customer. Definition of deliverables 140 can be put in a quote 152 or proposal 154. Thus, deliverable 140 is in terms that are used by, and understood by, customer 103. When one of these is accepted by the customer, the user can generate a contract 156 from the quote 152 or proposal 154. When the customer 103 signs the contract 156, user 104 can use project management component 112 to generate an internal plan using plan generator 114. The plan generator 114 will divide the work required to deliver the deliverable into tasks and subtasks. User 104 can then use resourcing component 110 to assign resources 130 to those tasks and subtasks so that they can be completed. As they are completed, progress reporting component 116 can be used to manage the project and report the progress on a given project. Component 116 illustratively allows user 104 to view progress on both the internal plan, and on the deliverables, on a single display so user 104 can easily tell whether the progress of the organization (as reflected in the internal plan) is meeting the expectations of the customer (as reflected in the deliverable). When progress commitments are met and invoices can be generated, user 104 can generate invoices 158 using invoicing component 118. At various points during the progress of the plan 124 (or after it is completed), user 104 can use performance engine 120 to evaluate the performance of the company against the deliverables. Performance engine 120 can generate revenue/performance reports 160, or a variety of other performance indicators.

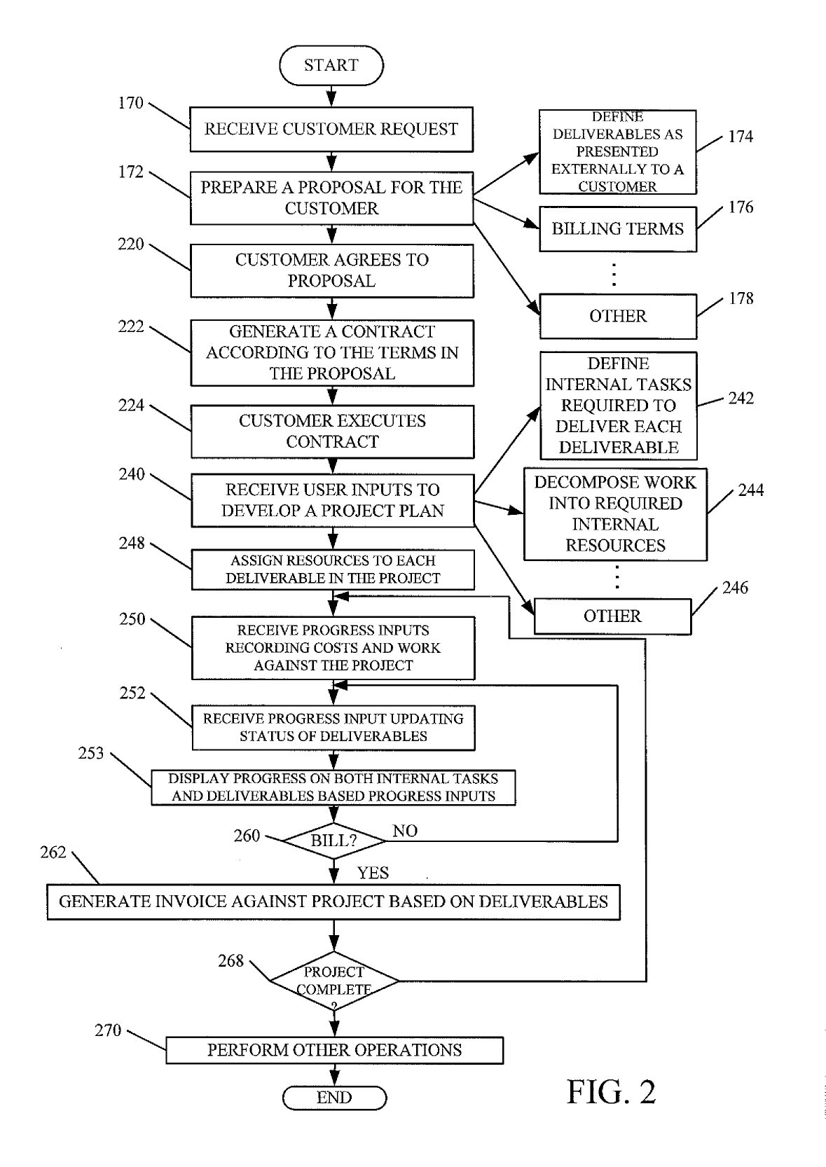

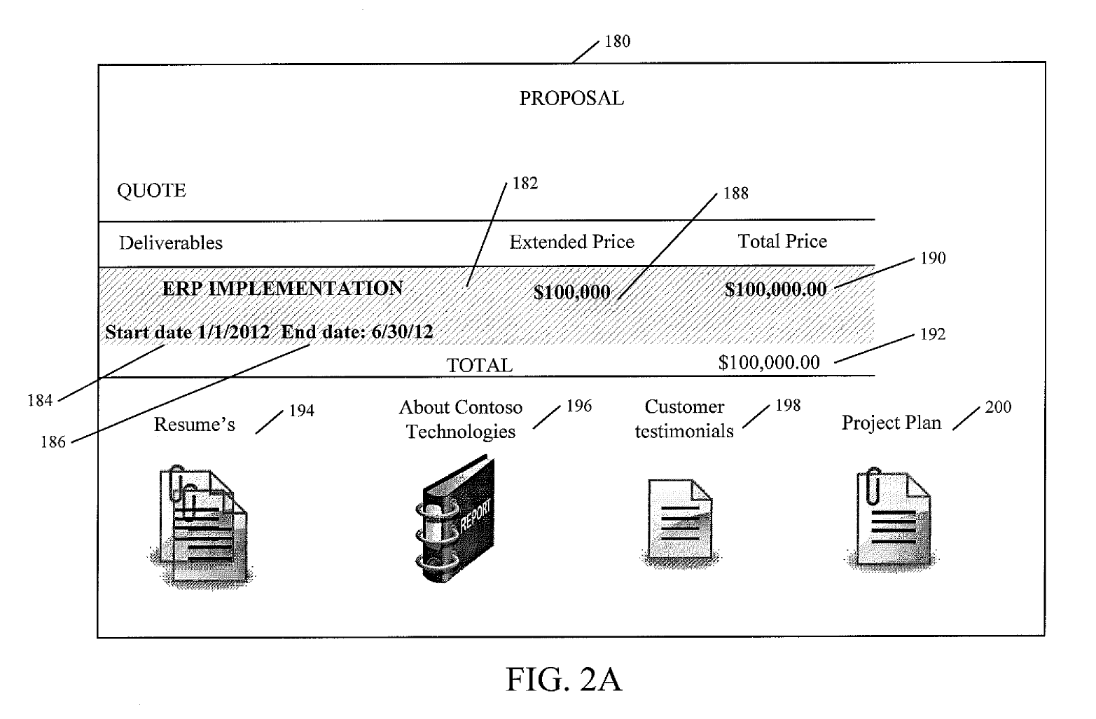

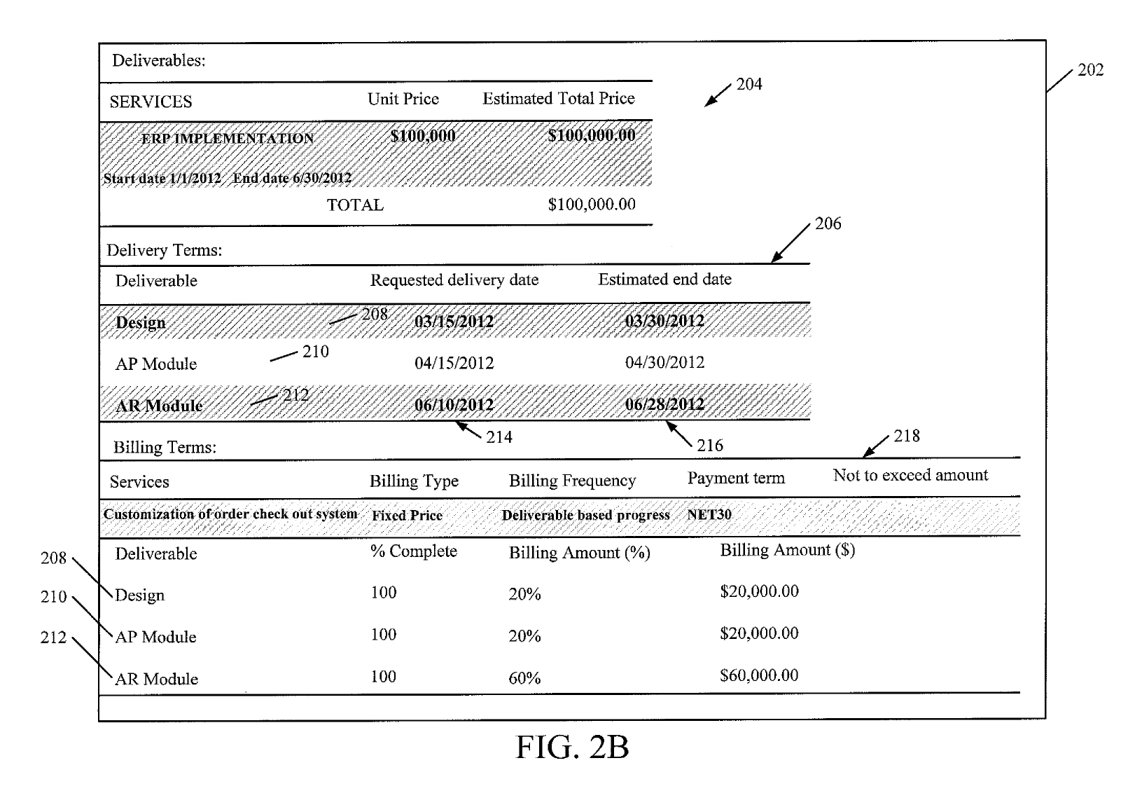

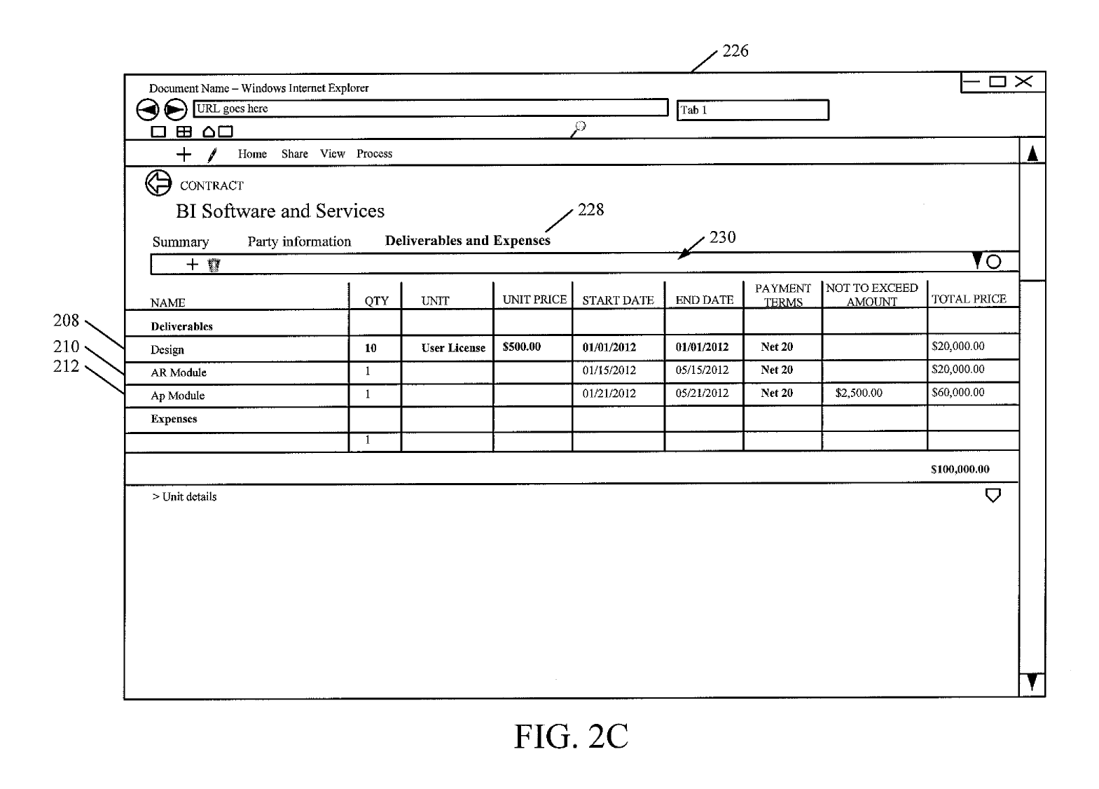

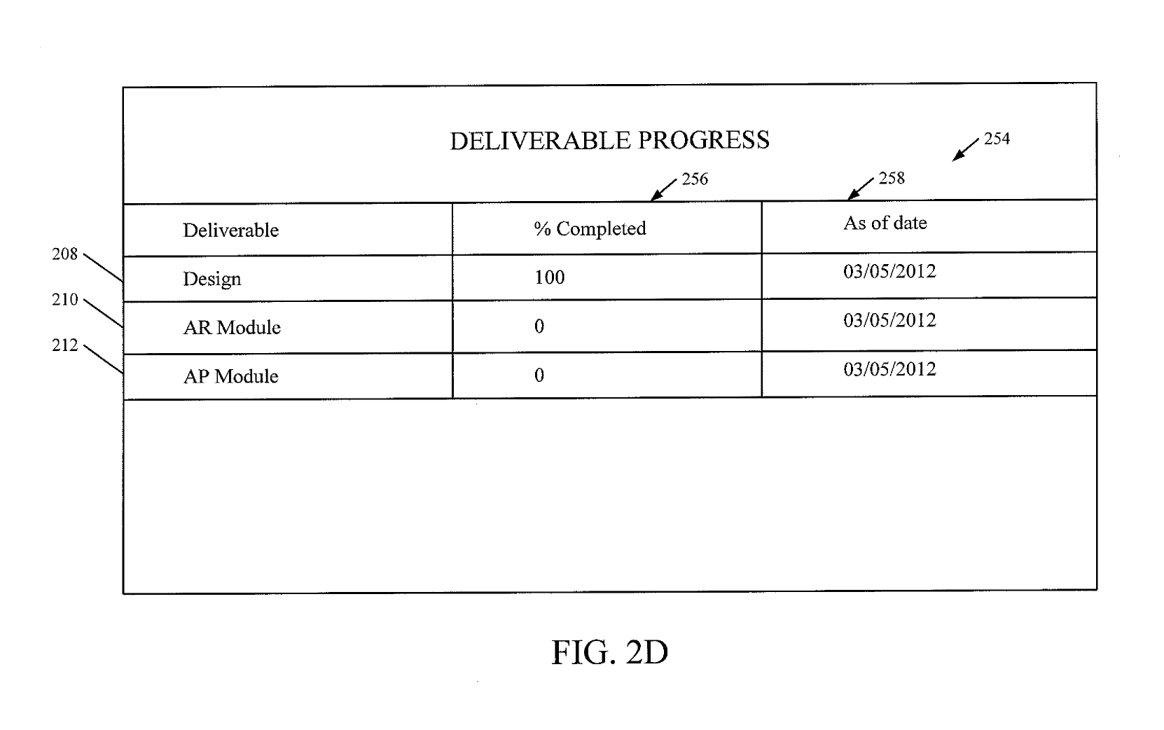

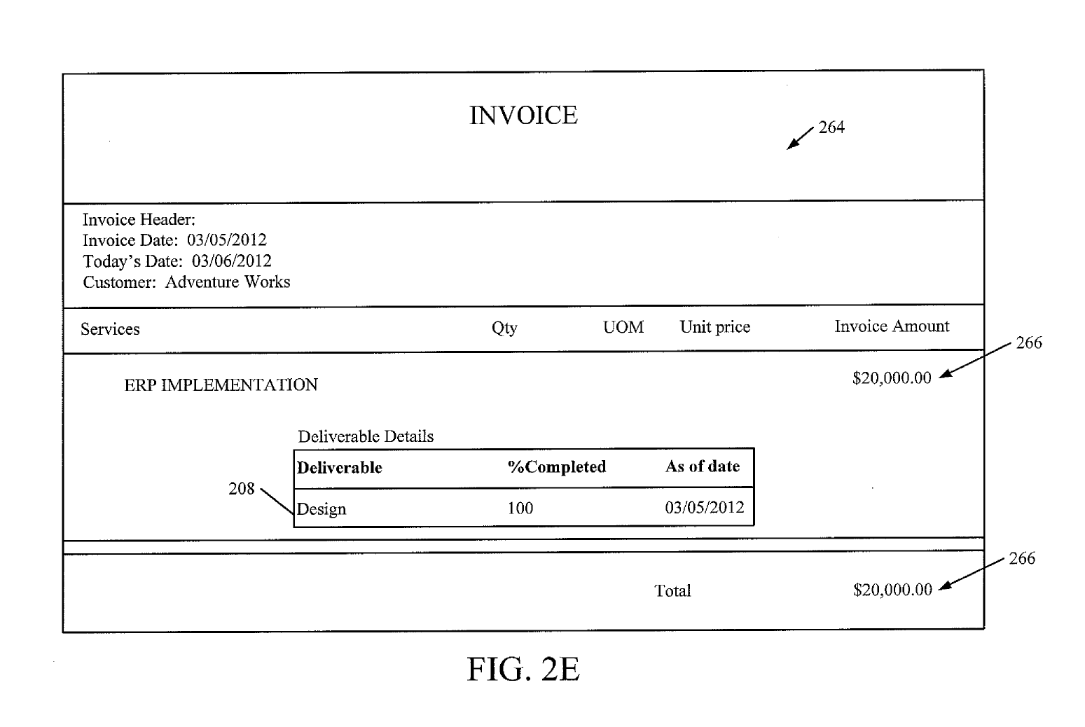

FIG. 2 is a flow diagram illustrating one embodiment of the operation of system 100 in more detail. FIG. 2 illustrates how system 100 can be used to define deliverables, design a project plan to deliver those deliverables, and manage both external commitments and internal tasks in that plan to completion and invoicing. System 100 first receives a customer request from customer 103, illustratively through customer interface 101. Of course, as discussed above, customer 103 can communicate with user 104 through a separate system as well, and those communications can be input into system 100 by user 104. However, for the sake of the present example, it will be assumed that customer 103 communicates with user 104 through system 100. Receiving the customer request is indicated by block 170 in FIG. 2.

In one embodiment, the request from the customer indicates a need that the user's company can fill by designing and performing a project to deliver deliverables to the user. Therefore, in response to receiving the request, user 104 uses system 100 to prepare a quote or proposal (152 or 154, respectively) for customer 103. This is indicated by block 172. In generating the proposal, user 104 illustratively interacts with customer 103 to define the specific deliverables 140 that the customer needs. Defining the deliverables is indicated by block 174 in FIG. 2. User 104 will illustratively include, in the definition of the deliverables, billing terms which indicate when the user can bill the customer for work done against the project. This is indicated by block 176. Further, of course, other information can be included in the proposal as indicated by block 178. It should be noted that the deliverable is defined in terms used by the customer, and reflect the external commitments made to the customer. The definition of the deliverables, itself, does not necessarily correspond to the internal tasks that will need to be done in order to complete the project and deliver the deliverables.

FIG. 2A shows one illustrative embodiment of a user interface display 180 that represents a quote or a proposal. It can be seen that, in one embodiment, the deliverables are “ERP Implementation” as indicated at 182. The proposal or quote also illustratively includes a start date at 184 and an end date at 186. The proposal also illustratively includes an extended price 188, a total price 190 and a total of all deliverables 192. In the embodiment shown, proposal 180 also illustratively includes links to resumes 194 for the workers, that are going to be performing on the deliverables, a link 196 to additional information about the company, a link 198 to customer testimonials and a link to the proposed project plan which is to be, or has been, designed to deliver the deliverables at 182. The proposed project plan link is indicated by numeral 200.

FIG. 2B illustrates a user interface display 202 that defines the deliverables in greater detail. In one embodiment, user interface display 202 is generated from user interface display 180 when the user actuates a button or link on display 180. Table 204 shows the same information that was disclosed in user interface display 180 in FIG. 2A. However, table 206 breaks the services for the project into three distinct deliverables. One is the design 208, the next is AP functionality 210, and the final is AR functionality 212. Each of the deliverables 208-212 has a requested delivery date shown in column 214 and an estimated end date shown in column 216. User interface display 208 also illustratively includes the billing terms table 218 that specifies when amounts can be billed against the project.

Once the customer 103 has reviewed the proposal, the customer can agree to the proposal. This is indicated by block 220 in FIG. 2. In response, user 104 can use contract generator 108 to generate a contract 156. Contract generator 108 imports the elements (including the definition of the deliverables 208-212) from the proposal shown in FIG. 2B into a contract, thereby filling out the various terms in the contract with the information shown in FIG. 2B. Generating a contract according to the terms in the proposal is indicated by block 222 in FIG. 2. The contract 156 can then be provided to customer 103 through customer interface 101, or in a different way, for execution by customer 103. Execution of the contract by the customer is indicated by block 224 in FIG. 2.

FIG. 2C shows another user interface display 226 which displays the deliverables in a portion of a contract. In FIG. 2C, the deliverables and expenses are displayed when the user actuates deliverables and expenses button 228 on user interface display 226. This causes table 230 to be displayed. It can be seen that table 230 also illustratively displays a quantity, unit, unit price, start date, end date, payment terms, not to exceed amount and total price for each of the deliverables 208-212.

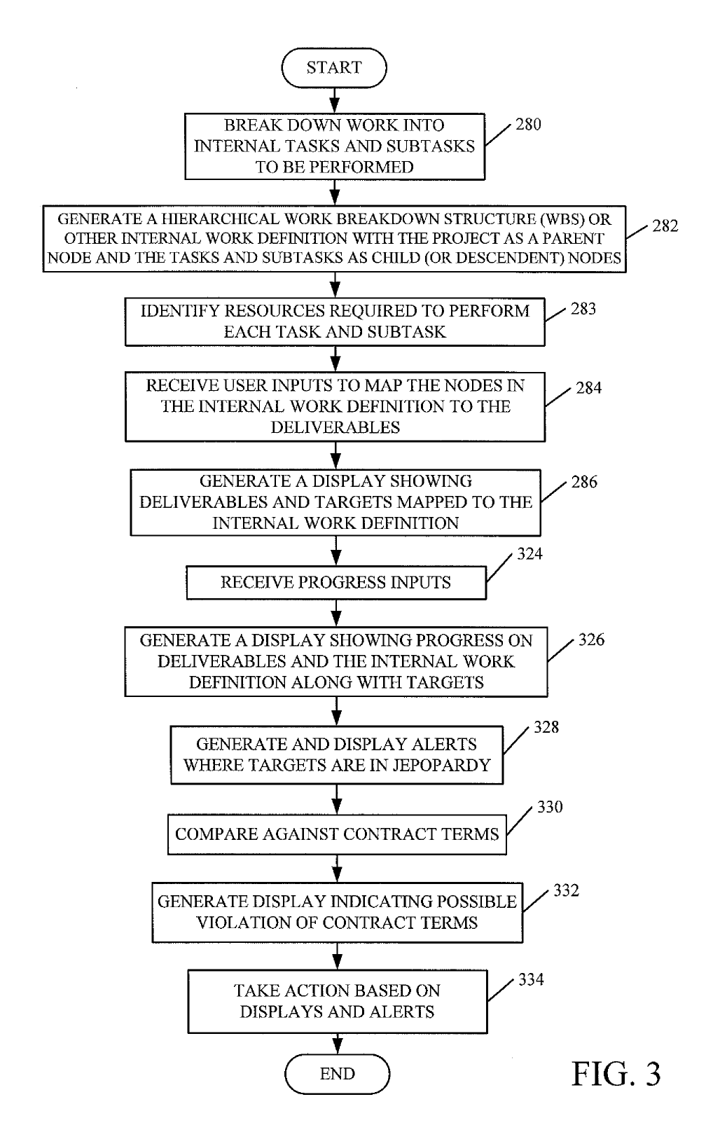

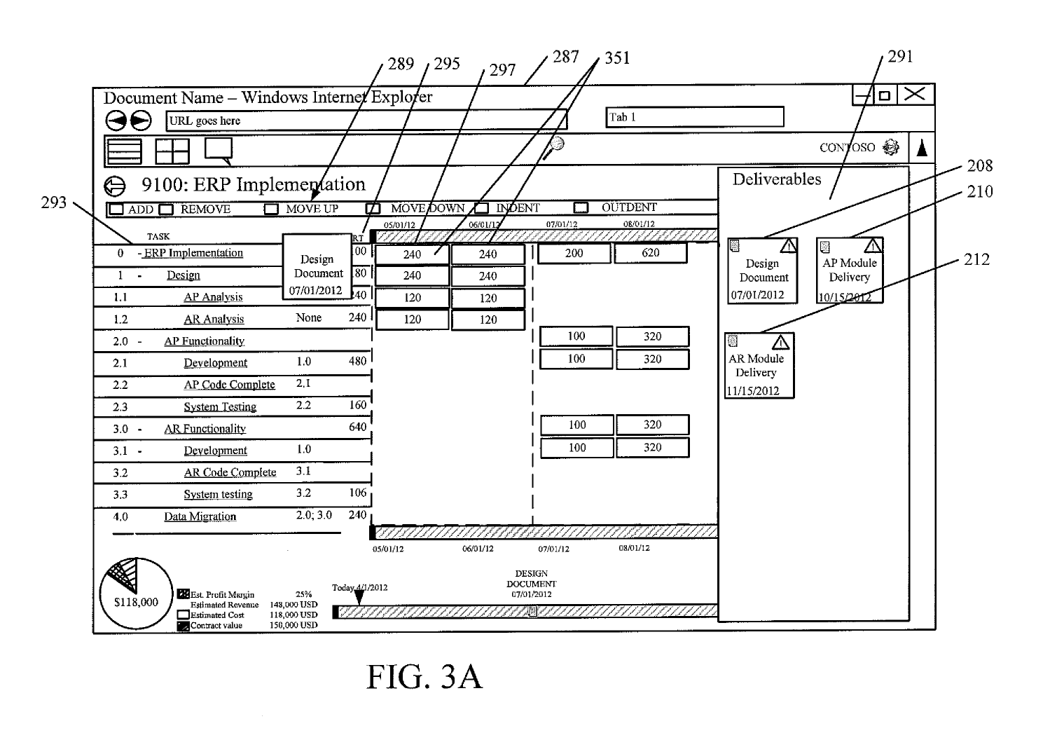

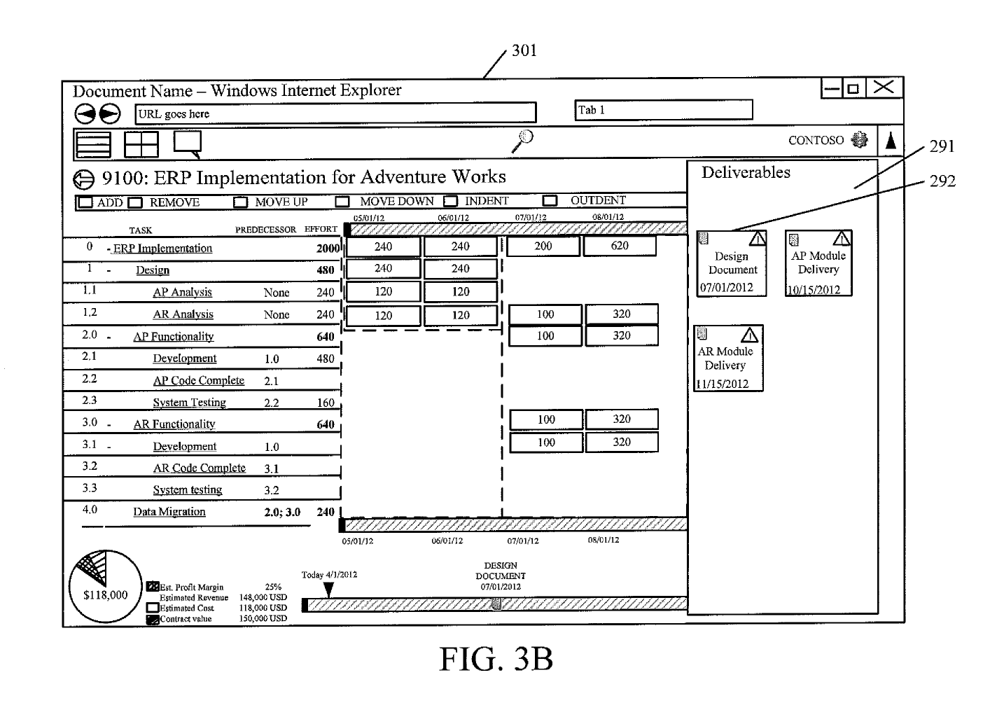

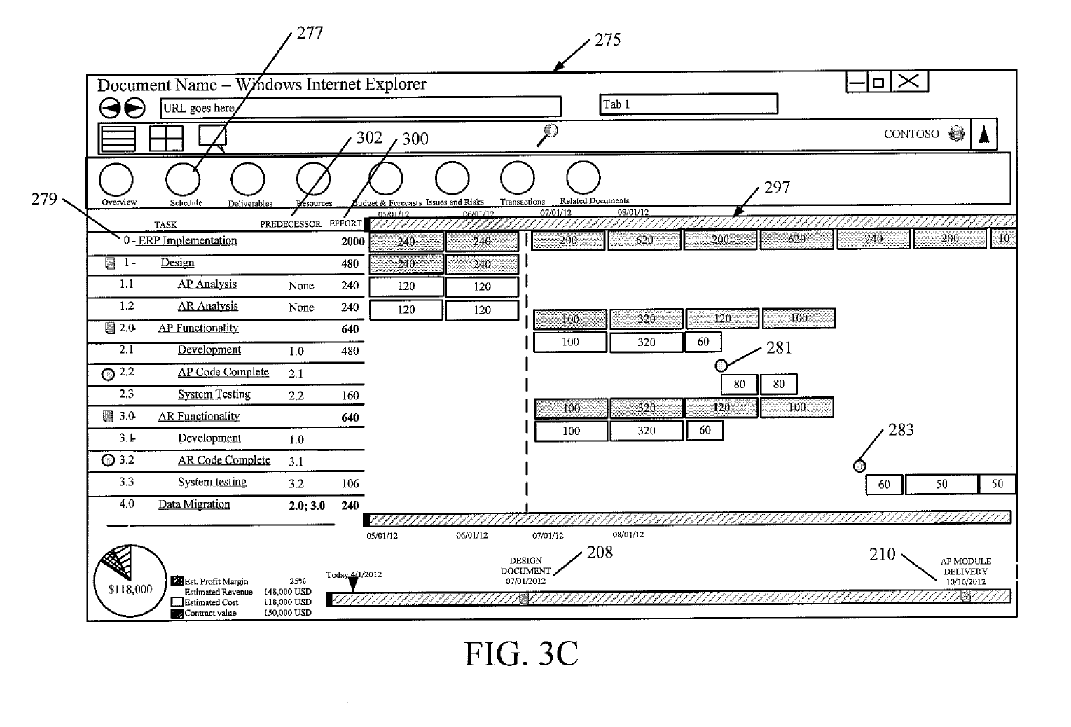

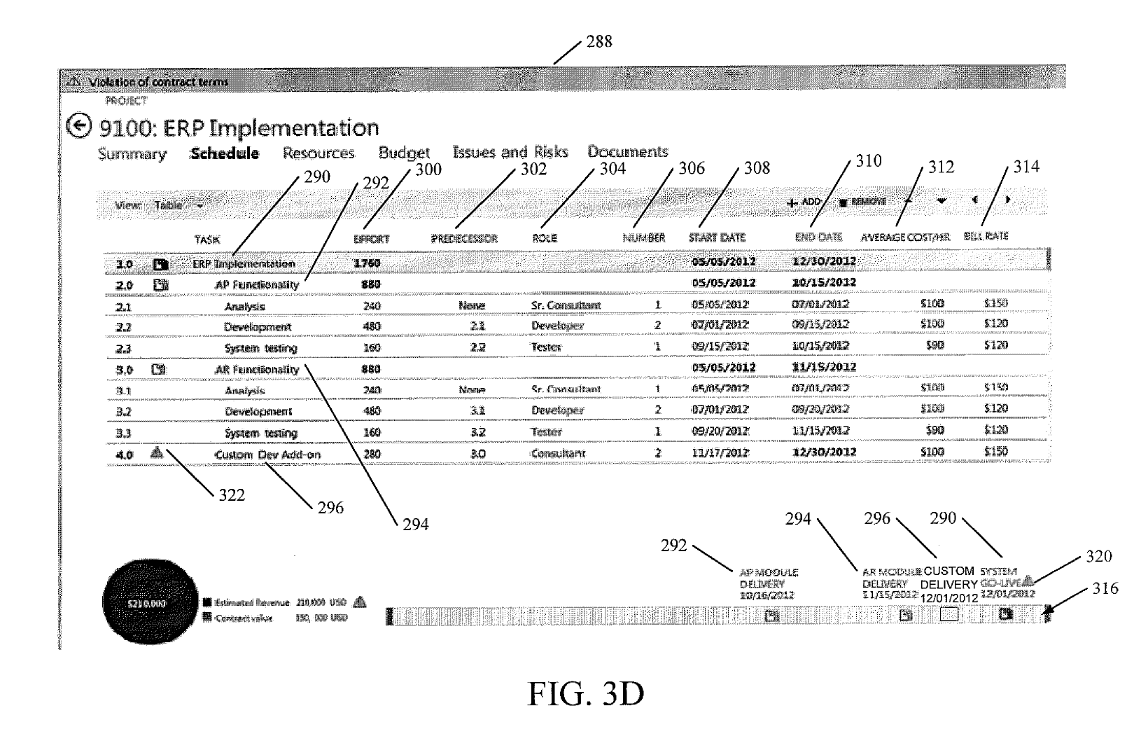

After the user has executed the contract, system 100 receives input from user 104 (and specifically plan generator 114 receives user inputs) to develop a project plan 124 by which the deliverables can be delivered to the customer 103. This is indicated by block 240 in FIG. 2. This is defined in greater detail below with respect to FIG. 3. Briefly, however, the user defines the work required (in terms of internal tasks to be performed) to deliver each deliverable. This is indicated by block 242. The user then decomposes that work into required resources as indicated by block 244, and the user can perform other actions in developing the project plan as well. This is indicated by block 246.

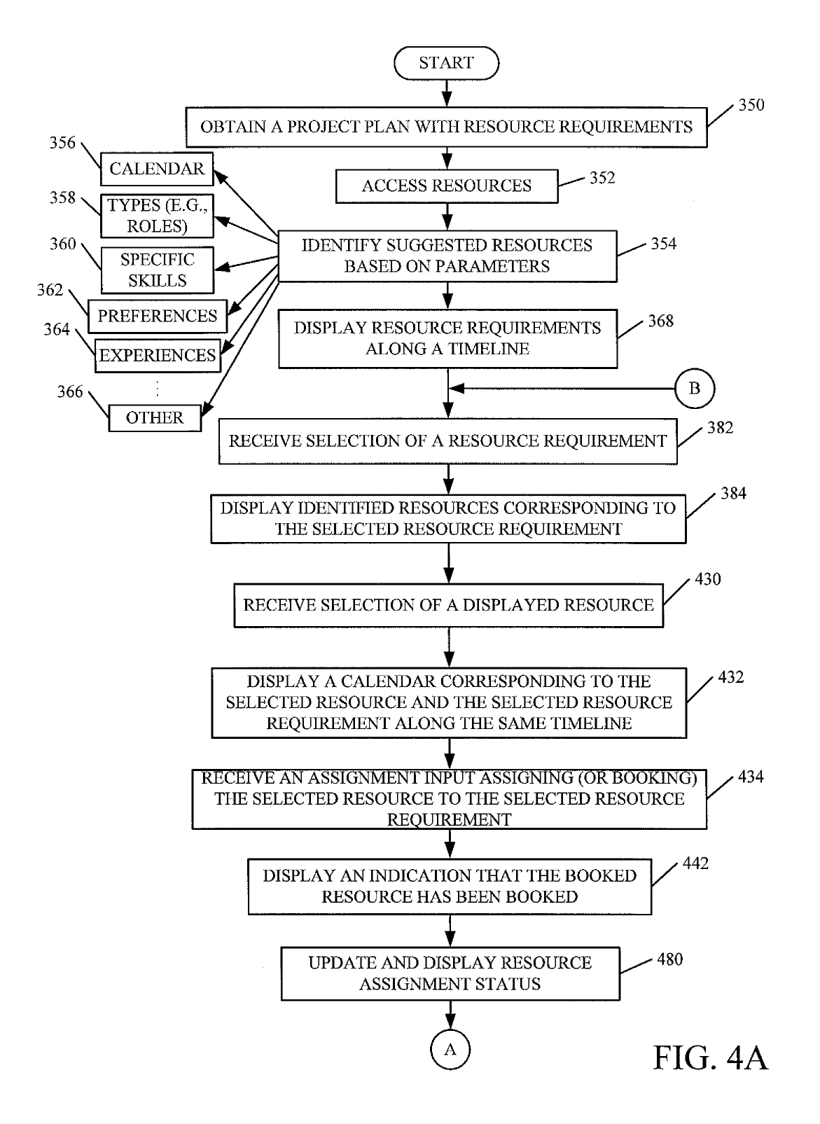

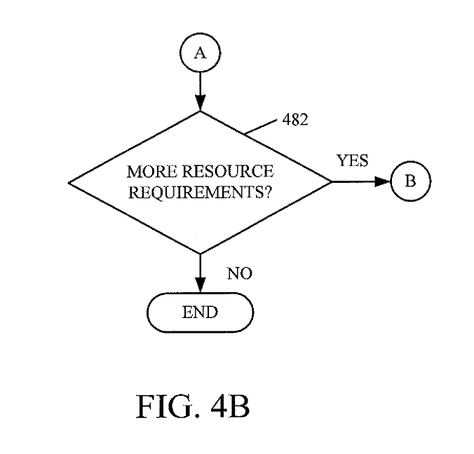

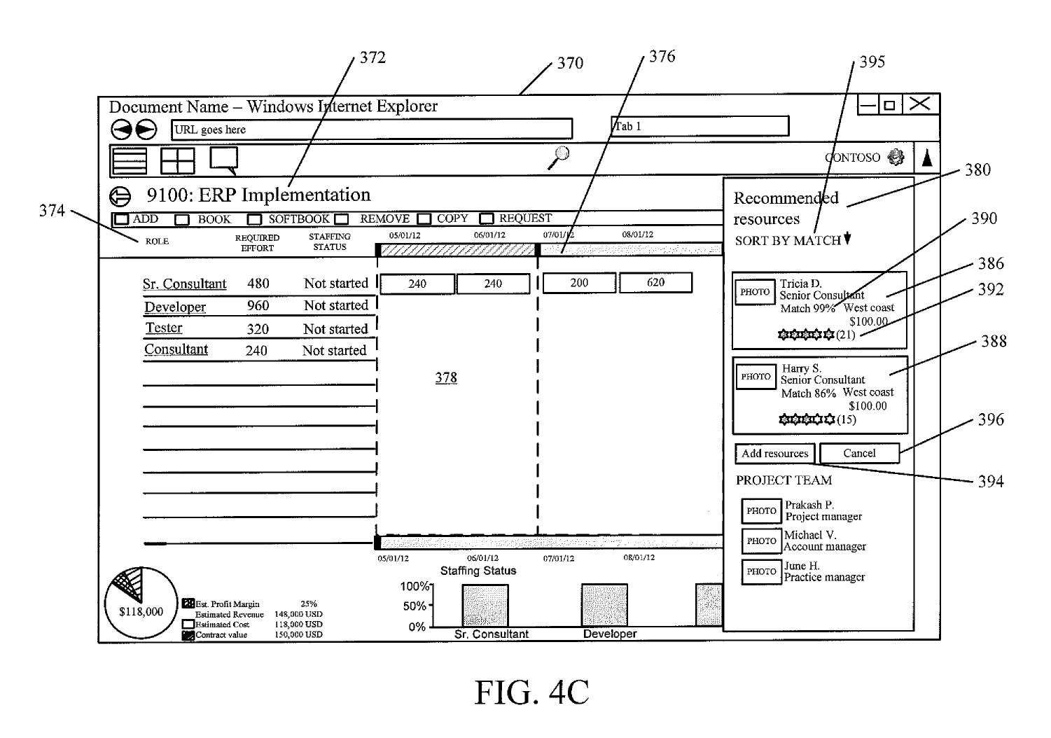

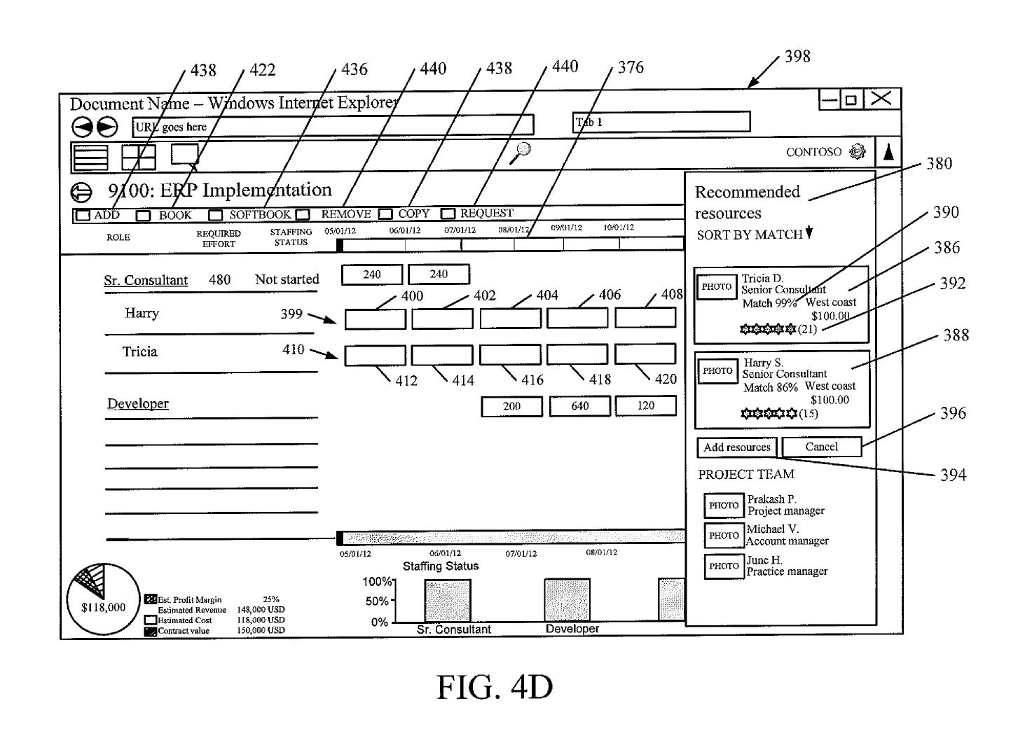

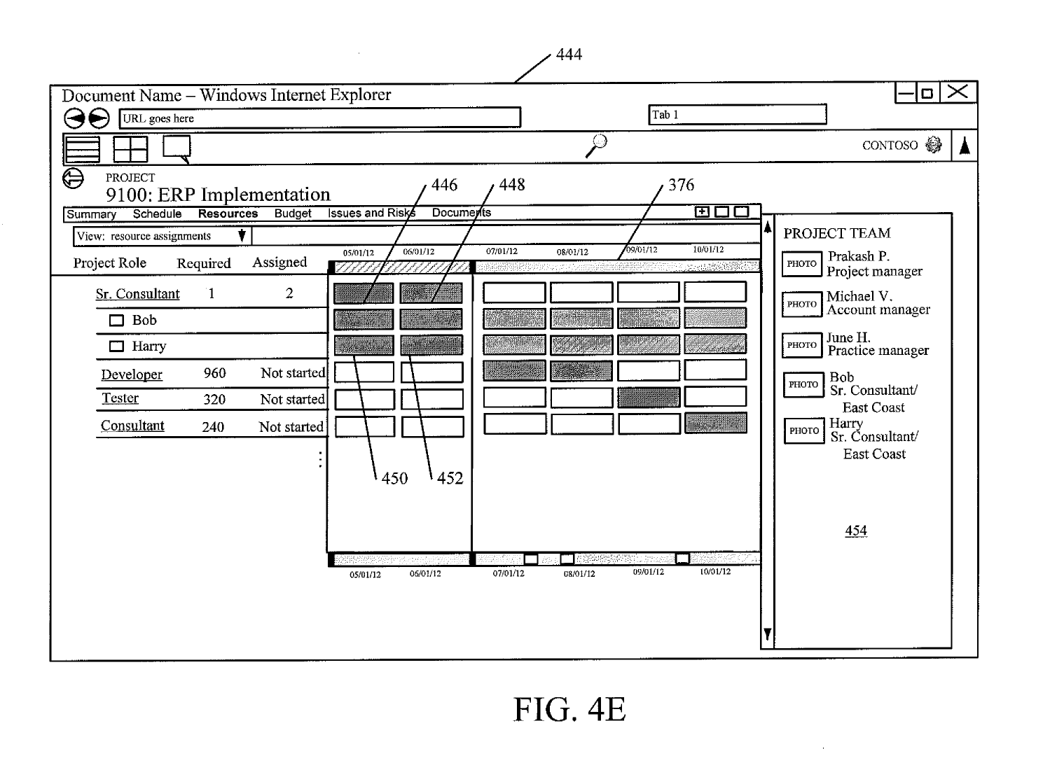

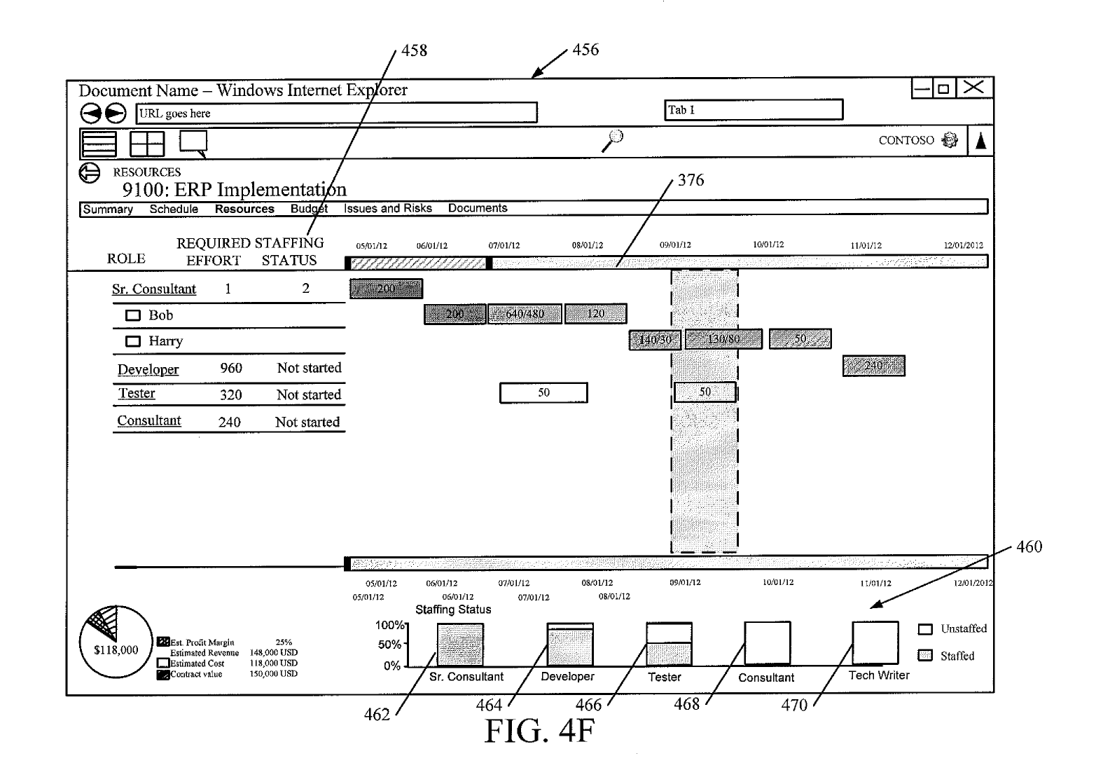

Once the project plan has been generated, user 104 can use resourcing component 110 to actually assign resources to each deliverable in the project plan. This is indicated by block 248 in FIG. 2. Recall that, at block 244, the user identified resources required for each task in a deliverable, and the user actually assigns those resources to each deliverable at block 248. This can be done in a wide variety of ways. In one embodiment, resourcing component 110 can generate a user interface display through which the user can view all available resources and assign those resources, based on the dates that the resources are available, to a given project plan. This can be done using drag and drop functionality. For instance, the user can drag available resources from one pane to tasks or subtasks in the project plan in another pane. Of course, assigning resources can be done in any other desired way as well, and a more detailed discussion of one embodiment is described below with respect to FIGS. 4-4F. In any case, user 104 illustratively assigns facilities 132, workers 134, equipment 136, or any other resources 138 to each deliverable in order to have the deliverable completed within a desired time.

Once the project plan 124 is completed, user 104 can use project management component 112 (and specifically progress reporting component 116) to manage the project and update the progress made toward delivering each deliverable. Invoice component 118 can also receive user inputs recording costs against the project. This is indicated by block 250 in FIG. 2. Receiving the inputs recording costs can simply be user 104 entering timesheet entries against the various deliverables in project plan 124, it can be entering travel expenses or other expenses, or it can be entering substantially any other costs against the project. User 104 can also use progress reporting component 116 to update the progress or status of each of the deliverables. This is indicated by block 252. In one embodiment, progress reporting component 116 generates a user interface display that shows both progress toward completing the internal tasks in the project plan and progress toward completing each deliverable. This is indicated by block 253 in FIG. 2.

FIG. 2D shows one example of an illustrative user interface display 254 that allows user 104 to update the progress of each deliverable. It can be seen that user interface display 254 displays the same deliverables 208-212, which are shown in the user interface display of FIG. 2B. User interface display 254 provides a percent completed column 256 which allows the user to select one of the cells in column 256 and update the percent completed. User interface display 254 also includes a date column 258 that allows user 104 to update the date that the percent completed number was actually completed.

Recall that the contract executed by the user and the customer will illustratively define the billing terms that specify when user 104 can invoice customer 103. In the embodiment shown in FIG. 2B, for instance, table 218 indicates that user 104 can invoice 20 percent of the contract amount when deliverable 208 is completed, and another 20 percent when deliverable 210 is completed and the last 60 percent when deliverable 212 is completed.

In one embodiment, invoice component 118 compares the invoice terms in the contract against the progress reported by progress reporting component 116 to determine whether a bill or invoice can now be generated. That is, invoice component 118 determines whether the criteria for sending an invoice have been met, based on the terms of the contract. Making this determination is indicated by block 260 in FIG. 2.

If the criteria for sending an invoice have not yet been met, the system simply waits until the progress has been updated sufficiently that an invoice can be generated. However, if an invoice can be generated, then invoice component 118 illustratively generates an invoice as indicated by block 262. FIG. 2E is one illustrative user interface display 264 that shows one invoice that can be generated by invoice component 118. It can be seen that the invoice generated includes a total of $20,000 (which is 20 percent of the contract amount) because the first deliverable 208 has been 100 percent completed. The invoice amount is indicated generally at 266 in FIG. 2E.

Project management component 112 then determines whether the project is complete. If so, and all of the invoices have been sent and paid, then additional processing can be performed as indicated by block 270. Other processing can be performed as well. When that is complete, processing can terminate with respect to this project plan 124. Determining whether the project is complete is indicated by block 268 in FIG. 2.

If the project has not been completed, and all invoices have not yet been generated and paid, then processing can revert back to block 250 where additional costs are recorded against the project and status of deliverables is updated and additional invoices are generated.

FIG. 3 is one embodiment of a flow diagram illustrating how system 100 operates to generate project plan 124 (as indicated by block 240 in FIG. 2), in more detail. In one embodiment, user 104 first uses plan generator 114 to breakdown the work that needs to be performed into internal tasks and subtasks. This is indicated by block 280 in FIG. 3. User 104 then uses plan generator 114 to generate a hierarchical work breakdown structure (WBS) or another type of internal work definition. In this type of hierarchical structure, the entire project is a parent node and the internal tasks and subtasks are child (or grandchild or other descendent) nodes. Generating this hierarchical structure is indicated by block 282 in FIG. 3.

User 104 then identifies the specific types of resources required to perform each task and subtask. This is indicated by block 283 in FIG. 3. For example, user 104 can determine that the design task 1.0 is to be performed by a Senior Consultant, while the development subtask 2.1 is to be performed by a developer. Of course, this will vary widely depending on the nature of the project. For instance, if the project was a construction project having an “excavation” task, then user 104 may identify that this task is to be performed by a “backhoe” resource type. These are exemplary only.

It should be noted that the hierarchical structure can be generated in a variety of different ways, and the types of resources required for each task and subtask can be defined in different ways as well. For instance, plan generator 114 can generate a user interface display 102 that has a set of tasks in one pane and the hierarchical structure in another pane. The user can drag tasks and subtasks from one pane to the other, and place them as nodes, and arrange dependency, in the hierarchical structure. In addition, plan generator 114 can generate a user interface display with the tasks and subtasks in one pane and resource types listed in another pane. The user can drag resource types to the tasks and subtasks. Of course, other ways of generating the hierarchical work breakdown structure (or other internal work definition) and the resource types are contemplated herein as well.

Once the work breakdown structure (or internal work definition) has been generated, user 104 can use plan generator 114 to provide user inputs that map the nodes in the WBS (or internal work definition) to the deliverables. This is indicated by block 284 in FIG. 3. This can be done in a variety of different ways as well. For instance, in one embodiment, the WBS that defines the work to be performed on a given project is displayed in one pane, and another pane shows the various deliverables. The user can use drag and drop functionality to cause various tasks or subtasks on the WBS to feed into one or more of the deliverables. This will indicate which tasks or subtasks in the WBS need to be performed in order to complete a deliverable. Once the mapping is performed, plan generator 114 illustratively generates a user interface display showing the deliverables and the various targets (such as completion dates, expense targets, etc.) from the contract mapped to the WBS (or other work definition). This is indicated by block 286 in FIG. 3.

FIG. 3A shows a user interface display 287 which allows the user to map the external commitments to the customer (e.g., the deliverables) onto nodes in the internal work definition. User interface display 287 includes a work definition pane 289 and a deliverables pane 291. Pane 289 includes a task/subtask column 293. The user can add and arrange dependency of internal tasks and subtasks using the “add”, “remove”, “move up,” move down,“, indent”, and “outdent” buttons, to move the nodes corresponding to each task or subtask around in column 293. Deliverables pane 291 includes deliverables 208, 210 and 212. The user can use a point and click device (or another device such as touch gestures where the display screen is a touch sensitive screen) to click on one of the deliverables 208-212 and to drag it over the task column 293 in table 289. In one embodiment, simply dragging a deliverable from pane 291 onto a node in column 293 causes plan generator 114 to map that deliverable to the internal task or subtask corresponding to that node. In another embodiment, the user can use the “add”, “remove”, “move up”, “move down”, “indent” and “outdent” buttons to move the deliverable to a desired node in the internal work definition. It can be seen in FIG. 3A that the user is mapping the design document deliverable 208 to the “design” node task 1 in the internal work definition in column 293.

FIG. 3A also shows that each of the subtasks under each task feeds into the task node. For example, the AP analysis and AR analysis subtasks 1.1 and 1.2, respectively, are each associated with an effort in column 295 of 240 hour blocks. It can be seen that those 240 hours, for each of subtasks 1.1 and 1.2, are divided into time periods of 120 hours along timeline 297. The total for each block along timeline 297, for both subtasks 1.1 and 1.2, are added to reach the total hours required for design task 1. Therefore, since each subtask 1.1 and 1.2 will require 120 hours between May 1^{st} and June 1^{st}, the design task 1 will require 240 hours (or effort units) for that same time period. This is shown in the hour boxes 351 below timeline 297. The same is true for the other tasks and subtasks shown in FIG. 3A.

FIG. 3B shows screenshot 301 which shows that the deliverables in deliverables pane 291 have been mapped to the nodes in column 293. For instance, user interface display 301 shows that the design document deliverable 208 has now been mapped to the design task node 1.

FIG. 3C shows a user interface display 275 that illustrates a tabular display of a plurality of different internal tasks and subtasks that are to be performed in order to complete the ERP Implementation project, as mapped to deliverables 208-212. This is displayed when the user actuates the schedule button 277 on the user interface display. As discussed with respect to FIG. 3A, the user has divided the work for the ERP implementation project into internal tasks and subtasks. The tasks include “Design”, “AP Functionality”, and “AR Functionality”. The subtasks are listed below, and indented, with respect to, each task. This is illustrated in column 279. To the right of the task column 279 are predecessor and effort columns 302 and 300, respectively.

The predecessor column 302 defines whether a corresponding task or subtask cannot be started until its predecessor is completed. For instance, the predecessor column shows that the AP Functionality subtask 2.1 cannot be started until the Design task 1.0 is completed. Other such predecessor relationships are also shown in the predecessor column.

User interface display 275 shows that each of the tasks and subtasks has been allocated a number of hours, and those hours have been spread across the entire timeline through which the project will be completed. The timeline is indicated at 297 and was briefly described with respect to FIGS. 3A and 3B, but will be described in more detail here. For a given time period, the hours for each subtask are summed to obtain the total hours, to be expended on the corresponding task during that same time period. For instance, FIG. 3C shows that for the time period between May 1, 2012 and Jun. 1, 2012, both the AP Analysis and AR Analysis tasks will require 120 hours worth of effort. Therefore, for that same time period, the “design” task will require 240 hours (which is the sum of its subtasks). Since no other tasks are being performed during that time period, the entire project will also require 240 hours worth of effort during that time period. However, it can be seen that in the time period between Jul. 1, 2012 and Aug. 1, 2012, the AP Functionality task has a subtask “development” which will require 100 hours worth of effort, and the AR Functionality task has a subtask “development” which also requires 100 hours worth of effort. Therefore, the “AP Functionality” and the “AR Functionality” tasks are summed to obtain a total of 200 hours worth of effort which will be required for the overall project between Jul. 1, 2012 and Aug. 1, 2012. This pattern continues along the timeline as shown in FIG. 3C.

FIG. 3C also illustrates milestones 281 and 283. Milestone 281 corresponds to the AP code development being complete. Milestone 283 corresponds to the AR code being complete. While the milestones are indicated by certain visual elements in FIG. 3C, it will of course be noted that different elements can be used, or milestones can be displayed by otherwise visually distinguishing them on user interface display 275.

FIG. 3D shows another illustrative user interface display 288 that illustrates another way of showing the set of tasks mapped to the set of deliverables. The project shown in user interface display 288 of FIG. 3D is an ERP implementation 290. Therefore, in one embodiment, the user has associated the root node in the WBS (or other internal work definition) with the entire “ERP implementation” project 290. Also, in one embodiment, the deliverables defined by user 104 and customer 103 (that must be performed in order to complete the ERP implementation 290) are to deliver AP functionality 292, AR functionality 294 and a custom development add-on 296. Deliverables 292 and 294 each have a plurality of tasks that must be performed to deliver the corresponding deliverable. Each of the tasks 2.1, 2.2 and 2.3 (which are numbers that identify these tasks on the internal work definition) feed into the AP functionality deliverable 294. That is, tasks 2.1, 2.2 and 2.3 must all be completed for the AP functionality 292 to be delivered. Similarly, tasks 3.1, 3.2 and 3.3 (which are numbers that identify these tasks on the internal work definition) must all be performed in order to deliver the AR functionality 294. Therefore, the table in user interface display 288 shows which tasks have been mapped to which specific deliverables.

FIG. 3D also shows that user interface display 288 has an effort column 300, predecessor column 302, role column 304, number column 306, start date column 308, end date column 310, average cost per hour column 312 and bill rate column 314. Of course, these columns are exemplary only and other columns, additional columns, or different columns could be used as well. The effort column 300, in the embodiment shown in FIG. 3D, shows the total number of effort units (in this case, hours) that will be required for the entire project 290 and for each of the tasks in each deliverable 292, 294 and 296. The predecessor column 302 indicates which tasks must be completed before other tasks. That is, predecessor column 302 shows that the analysis task 2.1 is a predecessor to the development task 2.2. Therefore, the analysis task 2.1 must be completed prior to completion of (or the beginning of) the development task 2.2. Of course, this is given by way of example as well.

Role column 304 indicates the particular role of a worker that is to perform the corresponding task. For instance, the analysis task 2.1 is to be performed by a Senior Consultant.

Number column 306 indicates the number of workers required to perform the task. Thus, only one Senior Consultant is required to complete the analysis task 2.1, for example.

The start and end date columns 308 and 310, respectively, indicate the expected start and end dates for the project as a whole, and for each task in each deliverable. These dates are updated based on progress inputs by user 104, or any of the other people who provide inputs to update the status of a given task, subtask, deliverable, or the project as a whole. As users input progress updates, the start date of a successor task may be moved based on the estimated completion date of a predecessor task. Similarly, the end date of any task, subtask, deliverable, or even the project as a whole, can be updated based upon the various progress inputs on any of the tasks that need to be completed and based upon the order of succession in which they need to be completed. For instance, if the end date of analysis task 2.1 is pushed out by a week, that means that the start date of development task 2.2 may need to be pushed by a week, and the end date of development task 2.2 may need to be pushed out by a week as well. The same is true of system testing task 2.3, because it has development task 2.2 as a predecessor. If that occurred, this, of course, would change the end date of the AP functionality deliverable 292 as well, because that end date is based upon the end dates of all of the tasks that flow into deliverable 292. It may also change the dates for other deliverables that have deliverable 292 (or a portion of it) as a predecessor, and it may change the dates for the entire project 290, as a whole.

Columns 312 and 314 display the average cost per hour and the billing rate for each of the tasks mapped to each of the deliverables.

In one embodiment, where target dates or target costs or expenses are in jeopardy (that is, where the target dates or target costs or expenses may be exceeded), project management component 112 illustratively highlights them on user interface display 288, or another similar user interface display. This will give the project manager a chance to identify certain tasks, subtasks, or deliverables that may be problematic. It should be noted that, in some embodiments, a given date or cost estimate on a task, subtasks or deliverables might be exceeded without necessarily violating or contract term. However, where progress updates indicate that contract terms may be violated, these can be illustrated as well. In one embodiment, for instance, once the progress updates are received (such as cost updates, percent completion updates, etc.) progress reporting component 116 compares the estimated end dates, the delivery dates of the various deliverables and the project as a whole, and the estimated costs, against those identified in the contract to identify possible violations of the contract.

User interface display 288 also includes a timeline 316 that plots the deliverables 292, 294 and 296, along with their delivery dates, on timeline 316. Timeline 316 also has the delivery date for the entire project 290 plotted on it as well. The deliverables and the delivery dates for the deliverables, on timeline 316, are obtained from the contract. Therefore, the delivery dates for the deliverables on timeline 316 are the delivery dates that are expected by the customer, based upon the executed contract. It can be seen from the table in user interface display 288 that the customized add-on deliverable 296 now has an end date which has been updated to Dec. 30, 2012. That means that the entire project 290 cannot be completed until Dec. 30, 2012. However, timeline 316 shows that it should be completed on Dec. 1, 2012, based on the terms in the contract which was executed by the customer.

The internal tasks are thus displayed along with the external commitments to the customers (i.e., the deliverables) on the single display in FIG. 3D. This allows the project manager (or other user) to quickly monitor whether the internal project is on track to meet the external customer expectations.

Therefore, project management component 112 illustratively identifies that, given the current progress on project 290, the company is not going to meet the delivery date for the project. Project reporting component 116 then generates an alert on user interface display 288. The alert can take one of a variety of different forms. In the embodiment shown in FIG. 3D, component 116 generates an exclamation point and alert marker 320 on timeline 316. This is because the delivery date for the final deliverable (and hence the entire project) is set in the contract at Dec. 1, 2012, but the estimated end date in column 310 is now Dec. 30, 2012.Component 116 also illustratively generates a warning marker 322 next to the deliverable, task or subtask which is causing the problem. Of course, there may be one or more tasks, subtasks or deliverables which are behind schedule, in which case a warning marker can be generated and displayed next to each one.

While the warning markers shown in FIG. 3D are exemplary only, it should be noted that others could be used as well. For instance, the task, subtasks or deliverable that is behind schedule may be displayed in bold, in red or another color, or visually distinguished from the remainder of user interface display 288 in another way. Receiving progress inputs against the various tasks and deliverables in the project is indicated by block 324 in FIG. 2, generating a display showing progress of deliverables, and the tasks in the internal work definition on a single display, along with targets, is indicated by block 326 in FIG. 3, and generating and displaying alerts where targets are in jeopardy is indicated by block 328.

Comparing the terms against the contract to identify possible contract violations is indicated by block 330 in FIG. 3. Generating a display indicating possible violation of contract terms is indicated by block 332.

Being aware of possible contract violations, the project manager can now better manage expectations with the customer. For instance, the project manager can communicate with the customer requesting a revision to the contract (such as the price, the delivery dates, or other terms of the contract) based upon the information displayed. Of course, the project manager can take other actions based on that information as well. For instance, the project manager may deploy more resources on completing a task or subtask mapped to a deliverable that is behind schedule. Because the tasks in the internal work definition are now tied to the deliverables expected by the customer, and displayed together on a single display, the project manager is better able to efficiently deploy resources to make sure the deliverables are delivered in a timely and cost efficient way. This also allows the project manager to more easily meet the expectations of the customer. Taking action based upon the displays and alerts is indicated by block 334 in FIG. 3.

FIGS. 4A and 4B (collectively FIG. 4) show a flow diagram that illustrates one embodiment of the operation of the system shown in FIG. 1 in assigning resources to resource requirements on a project plan. Resourcing component 110 first accesses data store 122 to obtain access to a project plan (such as plan 124) that has the resource requirements 144 defined in the deliverables in the project plan. Of course, while resourcing is described in context of the deliverables discussed above, it will be noted that it could be done in other contexts as well. For instance, instead of deliverables being defined as software components, the deliverables could be phases in a construction project, or other contexts. In any case, the project plan 124, that is accessed, will illustratively have resource requirements 144 defined therein. Obtaining the project plan with resource requirements is indicated by block 350 in FIG. 4.

Resourcing component 110 then accesses the available resources 130, based upon the resource requirements 144 in the project plan. Accessing the resources is indicated by block 352 in FIG. 4.

Resourcing component 110 then identifies suggested resources (from a store of resources 130) based upon a variety of different parameters. The parameters can be selected or input by user 104, or they can be predefined parameters, or they can be a combination of both. Identifying these suggested resources based on parameters is indicated by block 354 in FIG. 4.

By way of example, if project plan 124 is for the software services project discussed above, then the resource requirements 144 will primarily be defined in terms of roles. For instance, where a task in the project is designing a software module, the resource requirements may indicate that a senior software consultant must perform that task. Thus, the resource requirements will define that the design task requires 240 hours of Senior Consultant time. On the other hand, where the task is product development, the resource requirements may indicate (for example) that the development task requires 120 hours of developer time. Again, it will be noted that the resource requirement types are discussed in terms of roles by way of example only. The resource requirement types can be defined in other ways as well. The resource requirements will differ based the nature of the project. For instance, if the project is a construction project and the task is “excavating a foundation”, then the resource requirements will define that the task requires perhaps 100 hours of a backhoe or other excavator resource type.

Continuing with the present example where the project is a software design and development project, the parameters that resourcing component 110 might consider in identifying suggested resources includes the calendars for the workers (or other resources) that could fill the resource requirements, as indicated by block 356, the particular roles of those workers (such as Senior Consultant, developer, tester, or other resource types, etc.) as indicated by block 358, the specific skills that one of the workers may have as indicated by block 360, the preferences associated with the worker (such as whether the worker prefers to travel, work locally, or whether the worker prefers to work on certain types of projects, etc.) as indicated by block 362, the experience of the worker as indicated by block 364, or any of a wide variety of other parameters as indicated by block 366. Having considered the types of available resources 130, and the parameters 356-366, as well as the types of resource requirements for the task being considered, resourcing component 110 generates a user interface display showing the resource requirements for a project along a timeline. This is indicated by block 368.

FIG. 4C shows one example of a user interface display 370 that shows the resource requirements for a given project displayed along a timeline. The resource requirements for the ERP implementation project displayed at 372 are listed in a resource requirement type (or role) column 374. It can be seen that the types (e.g, roles) of the resource requirements for project 372 include a Senior Consultant, a developer, a tester and a consultant. The number of hours required for each resource are 480 hours for the Senior Consultant, 960 for the developer, 320 hours for the tester and 240 hours for the consultant. The status of whether a particular resource requirement has been staffed is also indicated, and this shows that none of the staffing has been started for any of the resource requirements.

Similarly, timeline 376 is displayed on user interface display 370. The time period during which each of the resource requirements is required, and the corresponding number of hours for that time period, are displayed along and below timeline 376. For instance, user interface display 370 shows that 240 hours of the Senior Consultant resource type are required for project 372 between May 1, 2012 and Jun. 1, 2012. Another 240 hours of the Senior Consultant resource type are required during the period of Jun. 1, 2012 and Jul. 1, 2012. Similarly, 200 hours of developer time are needed between Jul. 1, 2012 and Aug. 1, 2012, and 640 hours of developer time are needed between Aug. 1, 2012 and Sep. 1, 2012. These are all displayed in resource requirement pane 378. If the right border of resource requirement pane 178 is moved to the right, more of timeline 376 for project 372 is displayed, along with the resource requirements, as they are required along that timeline.

It should be noted that the resource requirements that are displayed can be aggregated from all the tasks and subtasks in the project plan. That is, the Senior Consultant resource (for example) may be needed in two or more different tasks at different times in the project plan. Resourcing component 110 illustratively aggregates the resource requirements for each resource type over all the tasks in the project plan and displays the aggregate requirements, when they are needed, along timeline 376. Of course, the resource requirements can be displayed on a per task basis, or otherwise.

User interface display 370 also includes a recommended resources pane 380. Recommended resources pane 380 shows the resources that are recommended by resourcing component 110, based upon the resource requirements and the other parameters (discussed above with respect to FIG. 4).

When the user selects one of the resource requirements 374, resourcing component 110 (using user interface component 128) identifies recommended resources for the selected resource requirement, and displays them in recommended resources pane 380. Receiving the selection of a resource requirement is indicated by block 382 and displaying identified resources corresponding to the selected resource requirement is indicated by block 384 in FIG. 4. It can be seen in FIG. 4C that the user has selected the “Senior Consultant” resource requirement for project 372. Therefore, resourcing component 110 has displayed, in recommended resources pane 380, two recommended resources for filling the “Senior Consultant” resource requirement. The first recommended resource is the Trisha D resource 386 and the second is the Harry S resource 388. Recommended resource 386 provides a name and description and type or role (e.g., Sensor Consultant) of the resource, the location and billing rate of that Senior Consultant, along with indicator 390 that indicates how closely recommended resource 386 matches the selected “Senior Consultant” resource requirement. It can be seen that recommended resource 386 matches the resource requirement at a rate of 99 percent, based upon the particular type of resource requirement, the type of resource, and the other parameters considered by resourcing component 110. Recommended resource 386 also includes a review status indicator 392 that indicates whether this particular recommended resource has been reviewed by other users and the rank assigned by those other users, along with the number of other users that have written reviews. Recommended resource 388 also illustratively includes this information as well.

User 104 can also change how resourcing component 110 displays these suggested resources. For instance, user 104 may simply desire that resourcing component 110 should display recommended resources that have calendars that precisely fit the selected resource requirement. In that case, user 104 can actuate dropdown menu 395 (or another suitable user input mechanism) to change the basis upon which resourcing component 110 sorts the recommended resources displayed in pane 380.

If user 104 determines that neither of the recommended resources 386 or 388 is suitable, or if user 104 would simply like to see additional resources, the user can illustratively actuate user input mechanism 394 which causes resourcing component 110 to display additional resources that meet at least a portion of the parameters being considered for the selected resource requirement. Of course, the user can also cancel the resourcing process by actuating cancel mechanism 396.

User 104 can select one of the recommended resources (or other resources displayed in pane 380 by simply clicking on the recommended resource or by dragging the recommended resource from pane 380) to pane 378, or in any other desired way. In the embodiment discussed herein, the user simply clicks on one of the recommended resources 386 or 388, and this causes resource component 110 to display the calendar of the selected recommended resource, closely proximate (or juxtaposed to) the resource requirements displayed along timeline 376. FIG. 4D shows one example of a user interface display 398 that illustrates this.

It can be seen that user 104 has selected both resource 386 and resource 388. Resource 388 (corresponding to Harry) was selected first. Therefore, resourcing component 110 displays Harry's calendar 399 juxtaposed to the calendar that shows the resource requirements for the “Senior Consultant” resource type. That is, it can be seen that user interface display 398 shows calendar blocks corresponding to the time periods on timeline 376, indicating whether Harry is available during those time periods. For instance, it can be seen that the blocks 400, 402, and 404 show that Harry is available (e.g., not booked on any other projects) between May 1, and Aug. 1, 2012. However, time block 406 shows that Harry is not available between Aug. 1, 2012 and Sep. 1, 2012. Then, between Sep. 1, 2012 and Oct. 1, 2012, block 408 shows that Harry is again available.

The calendar 410 corresponding to Trisha includes blocks 412 and 414 that show that Trisha is available between May 1, and Jul. 1, 2012. However, the remainder of the blocks in Trisha's calendar (blocks 416, 418 and 420) show that Trisha is not available between Jul. 1, and Oct. 1, 2012. Therefore, the user can select one of the resources (Harry or Trisha) by simply highlighting that resource and actuating the book actuator 422.

Because the calendar corresponding to the selected recommended resources are displayed in juxtaposed position relative to the calendar for the resource requirements, user 104 can quickly identify that both of the recommended resources (Harry and Trisha) are available as required by the “Senior Consultant” resource requirement type. This is shown in a single display. Similarly, however, the user 104 can quickly see that beginning on July 1, Trisha becomes unavailable. Therefore, if the timing corresponding to the completion of the project should slip at all, then user 104 may need to find another Senior Consultant to fill the resource requirement, or the user 104 may need to reallocate Trisha' s time because block 416 of her calendar shows that she is unavailable beginning on Jul. 1, 2012.

On the other hand, user 104 can also quickly see that Harry is available until Aug. 1, 2012. Therefore, even if the Senior Consultant resource requirement extends beyond the original projected time, Harry would still be available for an additional 30 days, because block 404 of Harry's calendar 399 shows that he is still available. If this is important to user 104, the user can book Harry as the resource to fill the “Senior Consultant” resource requirement instead of Trisha. Receiving selection of a displayed resource requirement in pane 380 is indicated by block 430 in FIG. 4 and displaying a calendar corresponding to the selected resource and the selected resource requirement along the same timeline 376 is indicated by block 432 in FIG. 4. Receiving the assignment input (or actuating book actuator 422) is indicated by block 434 in FIG. 4.

Once the user has actually booked a resource for a resource requirement (or assigned a resource to the resource requirement) resourcing component 110 generates a display indicating that the particular resource has been assigned to the resource requirement. For instance, the user interface display can be similar to that shown in FIG. 4D, except that blocks 400 and 402 are now highlighted or displayed with some other visual indication that Harry has been assigned to the Senior Consultant resource requirement in the project.

It should also be noted that while user 104 is attempting to staff a project, the user may try out different combinations of resources to fill different resource requirements. The user 104 may wish to do this before finally settling on a final set of resources that are assigned to fill the various resource requirements. In that case, the user can actuate the “soft book” user input mechanism 436. This displays the calendar corresponding to a selected resource in a different way, indicating that it has been soft booked, but not finally booked. This allows user 104 to try (and visually see) various combinations of different resources, as they are applied to the resource requirements for the project, so that the user can select the best combination of resources.

Of course, the user can add different resource requirements or resources by selecting the add button 438. The user can remove them by selecting remove button 440, and the user can copy various items by selecting the copy button 438.

It should also be noted that in one embodiment, user 104 can select or request a resource for a resource requirement, even if the resource has a calendar that is in conflict with the resource requirement. For instance, assume that the user desired to use Trisha to staff the Senior Consultant resource requirement, but that Trisha's calendar 410 indicated that Trisha was not available between Jun. 1, 2012 and Jul. 1, 2012. The user 104 can select Trisha and actuate the request button 440. This will indicate that Trisha has been requested to staff the resource requirement even though she is not available, based upon her calendar. A message can be sent to Trisha, or Trisha's manager, in an attempt to get Trisha reallocated to the present project, instead of the project she was previously booked for. In any case, generating a display showing that the booked resource has indeed been booked is indicated by block 442 in FIG. 4.

FIG. 4E is one example of a user interface display 444 that shows this. It can be seen in user interface display 444, that two Senior Consultants resources are required for the project. It can also be seen that two Senior Consultant resources “Bob” and “Harry” have been selected and booked to fill the resource requirements. Display 444 shows this by showing the calendars associated with the selected resources “Bob” and “Harry” in such a way that visually indicates that those resources have been assigned to the Senior Consultant resource requirement in the relevant time period. For instance, blocks 446 and 448 corresponding to Bob and Harry can be visually displayed (such as in a specific color with specific shading or other visual indications) showing that they have been assigned to the Senior Consultant resource requirement in the relevant time period along timeline 376.

In addition, user interface display 444 shows a project team pane 454 that shows all of the members of the project team (or other resources) that have been assigned to the project. The project team shown in pane 454 shows that Bob and Harry have been added as Senior Consultants to the project team.

After resources have been assigned to the resource requirements for a given project plan, resourcing component 110 updates the staffing status of each of the resource requirements to indicate whether it has been partially completed, fully completed, confirmed, or not yet started. FIG. 4F shows one example of user interface display 456 indicating this. User interface display 456 shows that the it includes a staffing status column 458 that shows that some of the staffing for the resource requirements is complete, some is partially complete, some is not yet started and some is confirmed. By confirmed, it is meant that even though a project manager staffs a given project by assigning resources to resource requirements, it may be that another individual, or the resources themselves, must confirm that staffing. If that is a requirement, then it is included in the staffing status column 458.

FIG. 4F also shows that user interface display 456 includes a staffing status chart 460. Chart 460 includes the resource requirements along the x-axis, and the percent complete along the y-axis. The percent complete refers to how much of the staffing has been completed for each of the resource requirements along the x-axis. For instance, in the embodiment shown in FIG. 4F, it can be seen that the Senior Consultant resource requirement has been completely staffed. Thus, the bar 462 corresponding to that resource requirement in chart 460 visually indicates that the staffing is complete. Bars 464 and 466 in chart 460 show that the developer and tester resource requirements have only been partially staffed, and bar 468 shows that staffing for the consultant resource requirement has not started yet. Similarly, the staffing for the Tech Writer has not been started and this is indicated by bar 470 in chart 460. Updating and displaying the resource assignment status is indicated by block 480 in FIG. 4.

User interface display 456 in FIG. 4F shows another feature. It may be that resource requirements are discontinuous along timeline 376. Those types of resource requirements can be very difficult to staff. However, user interface display 456 shows that, because the resource requirements are displayed along timeline 376, discontinuous resource requirements can easily be spotted. For instance, the “Tech Writer” resource requirement has discontinuous requirements between Jul. 1, 2012 and Aug. 1, 2012, and then again between Sep. 1, 2012 and Sep. 15, 2012. However, when user 104 is staffing the Tech Writer resource requirement and when user 104 selects a recommended resource, the schedule for that recommended resource will appear juxtaposed to the schedule for the Tech Writer resource requirement. The user can then very quickly and easily determine whether the selected resource is available during the proper time slots. Because this is all displayed in a single location, it can make staffing these types of resource requirements much easier and can save the project manager a great deal of time and effort in the staffing process.

Resourcing component 110 then determines whether there are more resource requirements that have not been staffed. This is indicated by block 482 in FIG. 4. If so, processing reverts back to block 382 where the user selects the next resource requirement to be staffed. Component 110 displays the resources recommended for that resource requirement, etc. If, at block 482, component 110 determines that resources 130 have been assigned to fill all of the resource requirements for the project, then processing is completed.

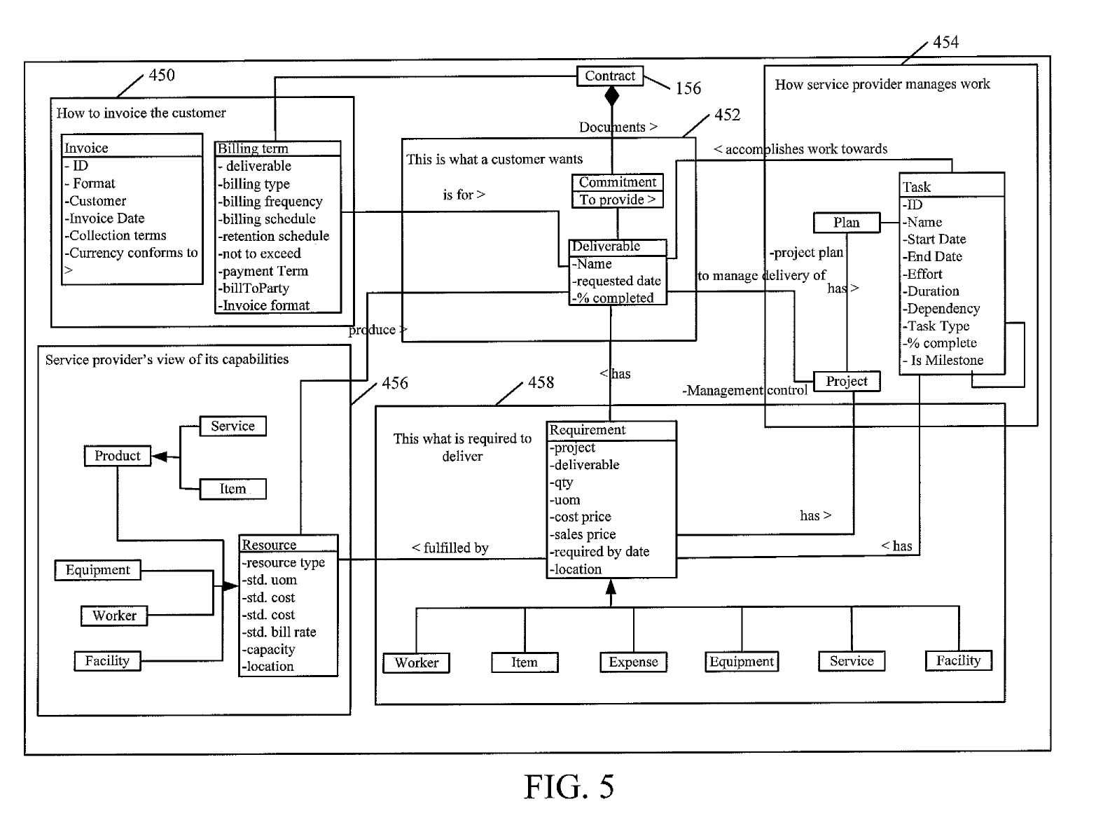

FIG. 5 shows one embodiment of a data model that can be used to implement system 100 shown in FIG. 1. The model in FIG. 5 is a UML diagram and it includes invoicing portion 450 that indicates how to invoice the customer. It also includes deliverables portion 452 that displays commitments and deliverables to the customer and provides them to contract 156. It includes a management portion 454 which indicates how the company is going to manage the work. It also includes resources portion 456 that allows the user or project manager to view the various resources at his or her disposal. Finally, it includes requirements portion 458 that shows the requirements that are needed to fulfill the contract 156.

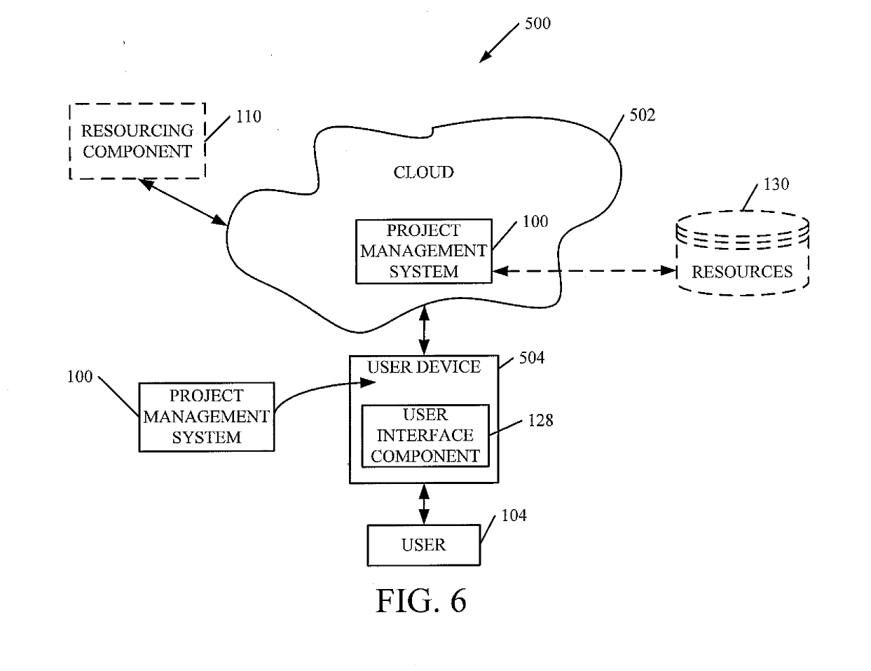

FIG. 6 is a block diagram of system 100, shown in FIG. 1, except that it is disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 6, some items are similar to those shown in FIG. 1 and they are similarly numbered. FIG. 6 specifically shows that system 100 is located in cloud 502 (which can be public, private, or a combination where portions are public while others are private). Therefore, user 104 uses a user device 504 to access those systems through cloud 502.

FIG. 6 also depicts another embodiment of a cloud architecture. FIG. 6 shows that it is also contemplated that some elements of business system 100 are disposed in cloud 502 while others are not. By way of example, resources 130 can be stored or disposed outside of cloud 502, and accessed through cloud 502. In another embodiment, resourcing component 110 (for example) is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

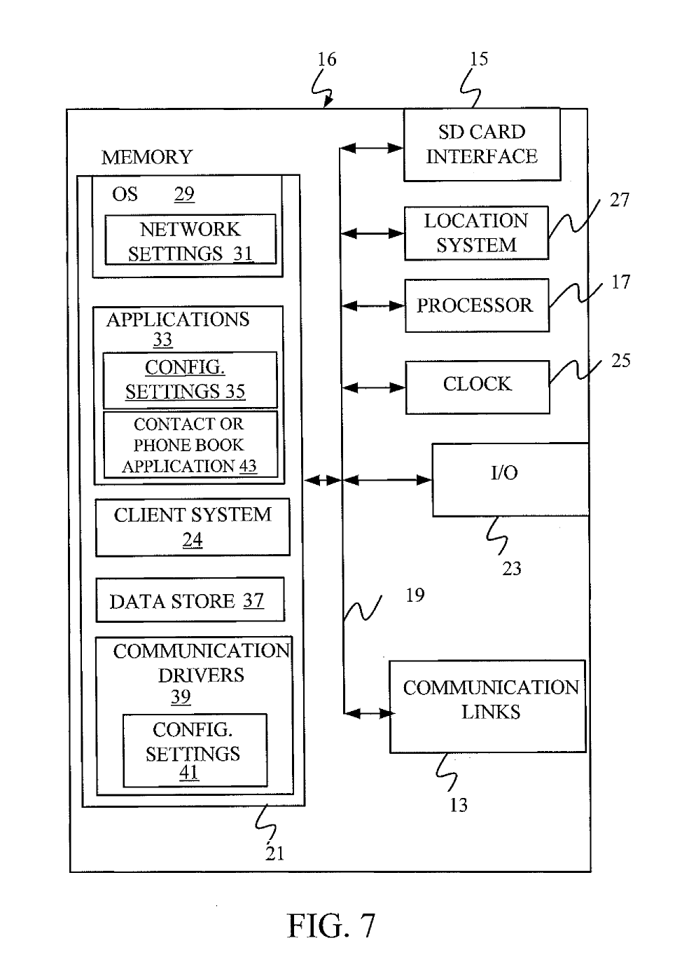

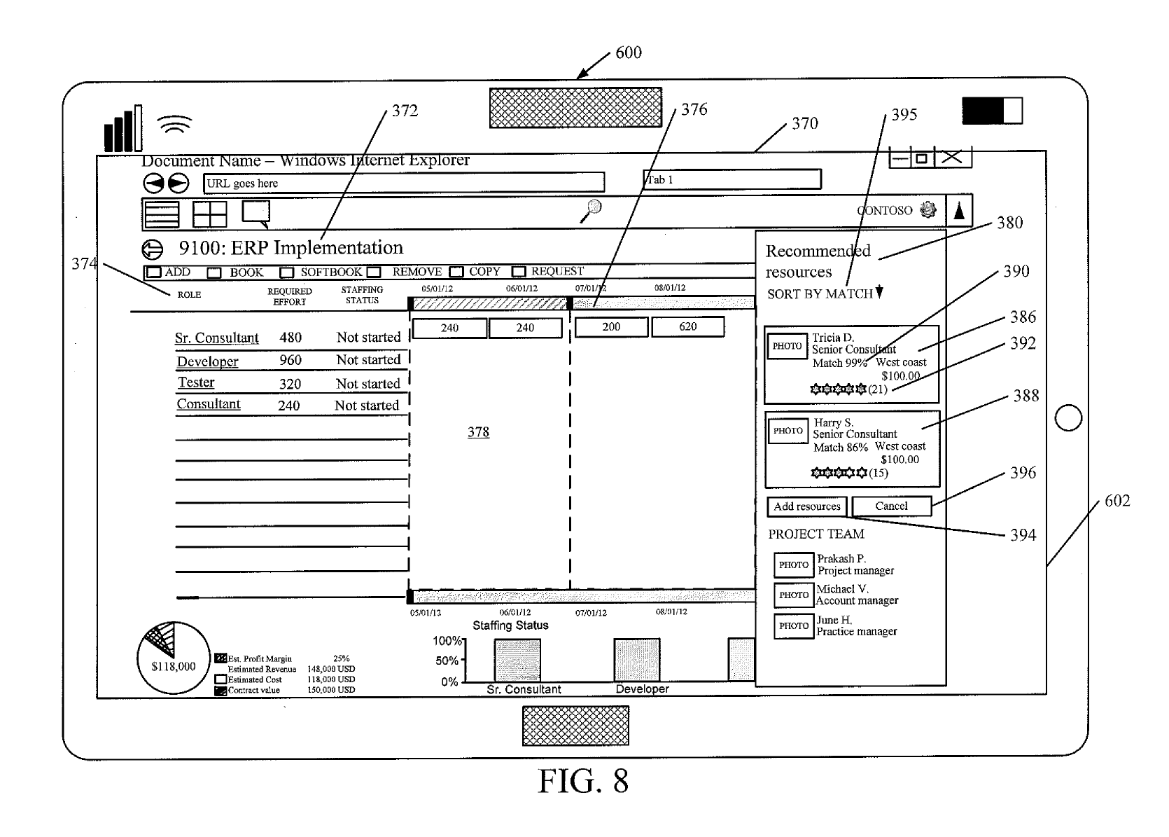

FIG. 7 is a simplified block diagram of one illustrative embodiment of a handheld or mobile computing device that can be used as a user's or client's hand held device 16, in which the present system (or parts of it) can be deployed. FIGS. 8-11 are examples of handheld or mobile devices.

FIG. 7 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processor 106 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 122, or resources 130 for example, can reside in memory 21. Similarly, device 16 can have a client system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

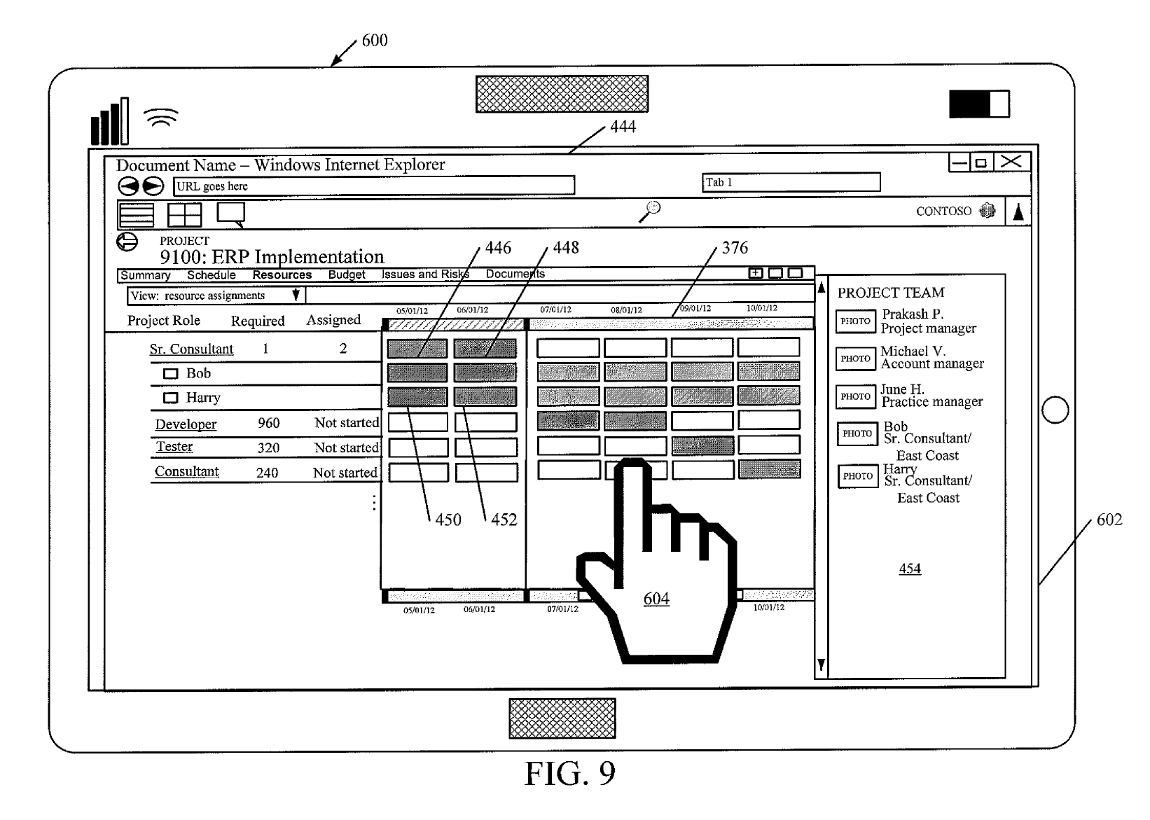

FIGS. 8 and 9 show one embodiment in which device 16 is a tablet computer 600. In FIG. 8, computer 600 is shown with user interface display 310 displayed on the display screen 602. FIG. 9 shows computer 600 with user interface display 444 displayed on display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

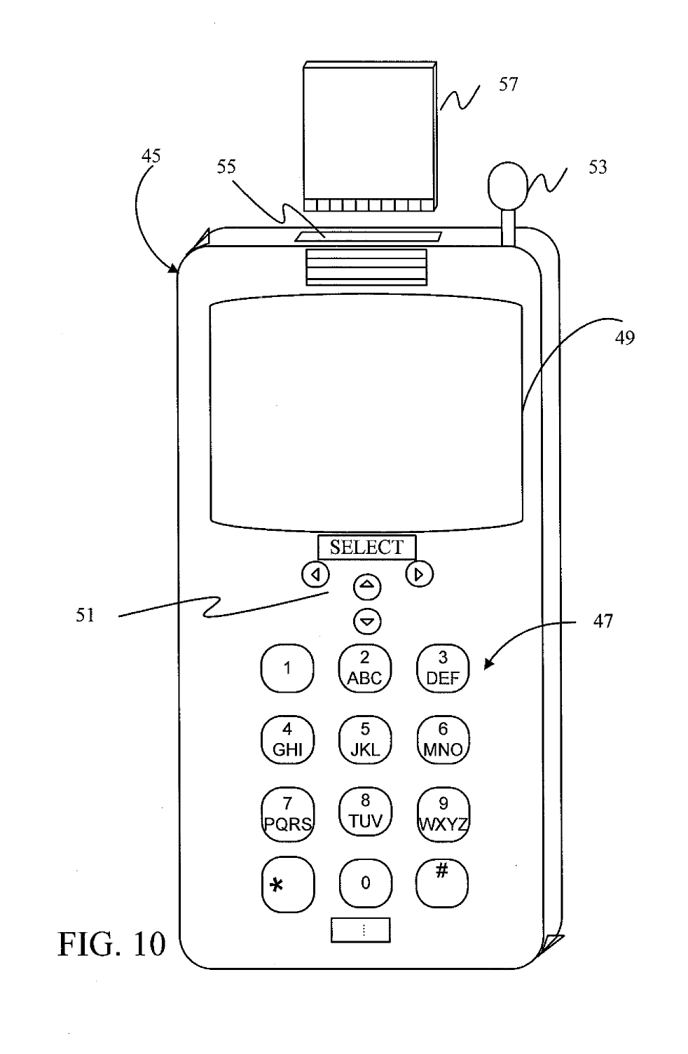

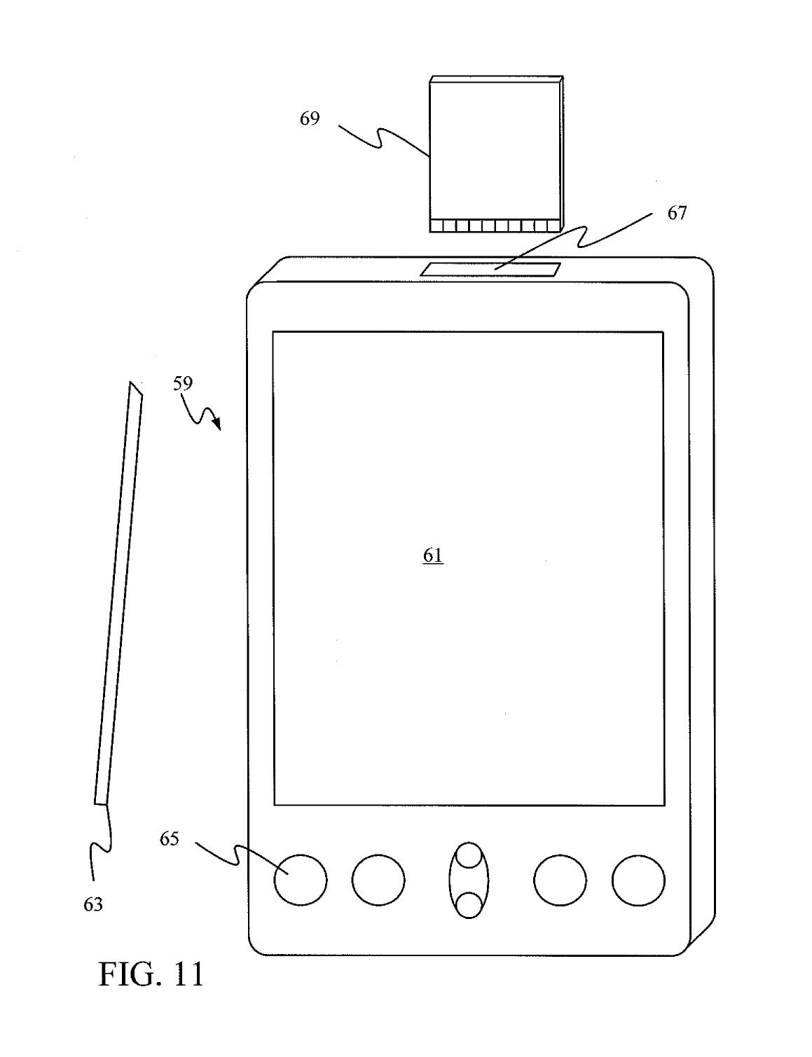

FIGS. 10 and 11 provide additional examples of devices 16 that can be used, although others can be used as well. In FIG. 10, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 11 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

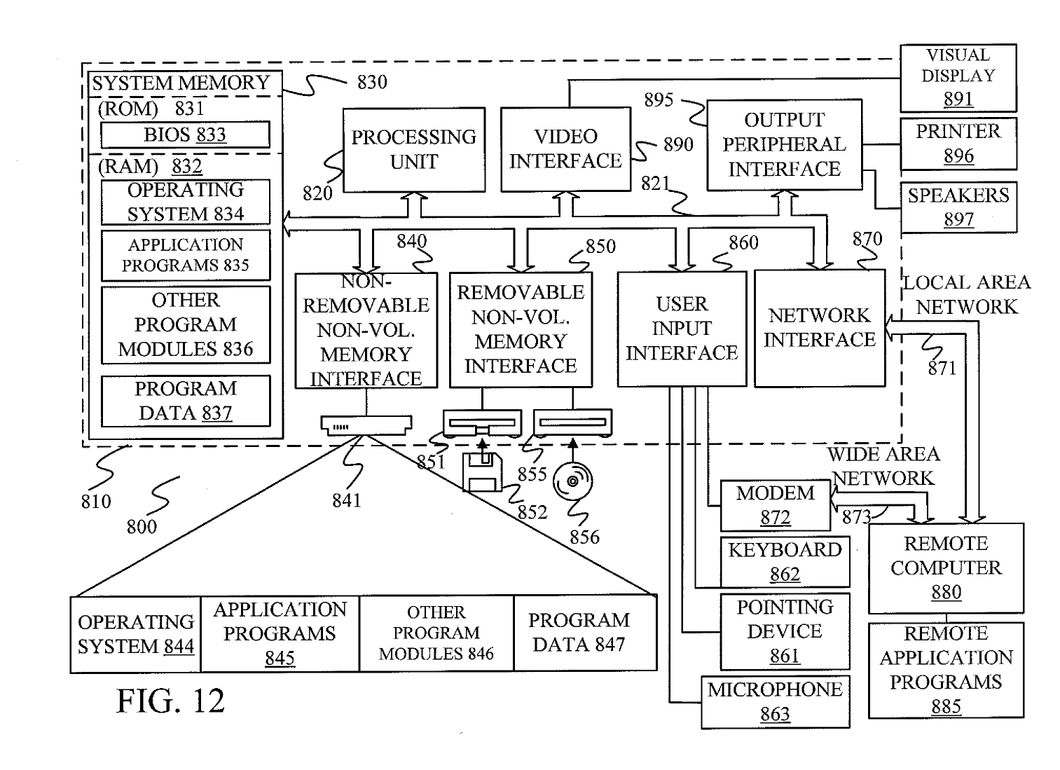

FIG. 12 is one embodiment of a computing environment in which system 100 (for example) can be deployed. With reference to FIG. 12, an exemplary system for implementing some embodiments includes a general-purpose computing device in the form of a computer 810. Components of computer 810 may include, but are not limited to, a processing unit 820 (which can comprise processor 106), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 12 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of assigning resources to work to be performed in a project plan, comprising:
obtaining a project plan with resource requirements for the project plan defined along a timeline;
displaying a resource requirements display showing the resource requirements along the timeline; and
receiving user assignment inputs assigning resources to meet the resource requirements.

2. The computer-implemented method of claim 1 and further comprising:
receiving selection of a resource requirement; and
displaying the selected resource requirement along the timeline; and
while the selected resource requirement is displayed along the timeline, displaying availability, for a given resource that meets the selected resource requirement, along the timeline.

3. The computer-implemented method of claim 2 wherein receiving user assignment inputs comprises:
receiving a user assignment input assigning the given resource to the selected resource requirement in the project plan; and
displaying a visual assignment indicator indicating that the given resource has been assigned to the selected resource requirement.

4. The computer-implemented method of claim 3 and further comprising:
while the selected resource requirement is displayed along the timeline, displaying a set of resources in a resource pane.

5. The computer-implemented method of claim 4 wherein displaying availability for a given resource comprises:
receiving user input selection of a first resource in the set of resources in the resource pane as the given resource.

6. The computer-implemented method of claim 5 wherein each resource requirement has a start date and an end date on the timeline and wherein the timeline extends beyond the end date of the resource requirement, and wherein displaying availability for a given resource comprises:
displaying the availability for the given resource along the timeline from the start date to a date after the end date.

7. The computer-implemented method of claim 5 and further comprising:
receiving user selection of a second resource in the set of resources in the resource pane; and
displaying availability, for the second resource, along the timeline.

8. The computer-implemented method of claim 7 and further comprising:
displaying availability, for both the first and second resources, along the timeline.

9. The computer-implemented method of claim 4 wherein the selected resource requirement has a resource requirement type, wherein each resource has a resource type, and wherein displaying the set of resources comprises:
identifying each resource in the set of resources based on the resource type, the resource requirement type, when each resource is available, and when each resource requirement is needed; and
displaying the identified resources as the set of resources.

10. The computer-implemented method of claim 9 wherein identifying each resource, comprises:
identifying each resource in the set of resources based on additional parameters, including at least one of resource experience, prior resource evaluations, resource preferences, resource cost, and specific resource skills.

11. The computer-implemented method of claim 10 and further comprising:
receiving user parameter inputs identifying the additional parameters used to identify the resources in the set of resources.

12. The computer-implemented method of claim 11 and further comprising:
displaying a match selector that receives a match selection user input indicating a given set of parameters for which the resources in the set of resources are to be ranked, and displaying the resources in the set of resources in rank order based on the given set of parameters.

13. The computer-implemented method of claim 9 wherein the project plan includes a plurality of tasks, each task having a resource requirement, and wherein displaying the resource requirements display comprises:
aggregating resource requirements for common resource types in the project plan to obtain an aggregate resource requirement for each resource requirement type; and
displaying the aggregate resource requirement for each resource requirement type along the timeline.

14. The computer-implemented method of claim 13 and further comprising:
displaying an assignment status display indicating a status of assignments for each resource requirement type.

15. The computer-implemented method of claim 13 and further comprising:
displaying an assignment level display indicating a level of assignments for each resource requirement type.

16. A project management system, comprising:
a resourcing component that obtains a project plan that has resource requirements defined therein, displays a user interface display showing the resource requirements displayed along a timeline, and provides a user input mechanism to receive user inputs to assign resources to the displayed resource requirements and to visually indicate which resources are assigned to which resource requirements along the timeline; and
a computer processor that is a functional part of the system and that is activated by the resourcing component to facilitate displaying the user interface display and receiving the user inputs to assign the resources to the displayed resource requirements.

17. The project management system of claim 16 and further comprising:
a resource store storing a plurality of different resources of different resource types along with corresponding calendar information showing availability of each corresponding resource, the resourcing component receiving a user selection of a resource corresponding to s selected resource requirement and displaying the calendar information corresponding to the selected resource along the timeline along with the resource requirement.

18. The project management system of claim 17 wherein the resourcing component identifies a set of resources in the resource store based on the resource requirement type of the selected resource requirement, based on the resource type of the resources and based on the calendar information, and displays the set of resources identified.

19. A computer readable storage medium storing computer readable instructions which, when executed by a computer, cause the computer to perform a method comprising:
obtaining a project plan with resource requirements for the project plan defined along a timeline;
displaying a resource requirements display showing the resource requirements along the timeline;
receiving selection of a resource requirement;
while the selected resource requirement is displayed along the timeline, displaying availability, for a given resource that meets the selected resource requirement, along the timeline; and
receiving user assignment inputs assigning resources to meet the resource requirements.

20. The computer readable storage medium of claim 19 wherein each resource requirement has a start date and an end date on the timeline and wherein the timeline extends beyond the end date of the resource requirement and further comprising:
while the selected resource requirement is displayed along the timeline, displaying a set of resources in a resource pane;
displaying availability for a given resource comprising receiving user input selection of a first resource in the set of resources in the resource pane as the given resource;
displaying the availability for the given resource along the timeline from the start date to a date after the end date;
receiving user selection of a second resource in the set of resources in the resource pane; and
displaying availability, for the second resource, along the timeline.
